(19) United States
(12) Patent Application Publication
(10) Pub. No.: US 2009/0072954 A1
(43) Pub. Date: Mar. 19, 2009

(54) COMMUNICATIONS METHOD AND DEVICE

(76) Inventors: Stephen M. Kim, Shanxi (CN); Stuart R. Bannister, Victoria (AU); Denis D. Bozic, Victoria (AU); Song Cui, Victoria (AU)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 12/066,670

(22) PCT Filed: Apr. 26, 2006
(86) PCT No.: PCT/AU06/00530

§ 371 Date: Aug. 29, 2008

(30) Foreign Application Priority Data
Apr. 26, 2005 (AU) 2005902067

(51) Int. Cl. G05B 11/01

(52) U.S. Cl. 340/310.13; 340/310.11

(57) ABSTRACT

The present invention relates to communications devices and methods, particularly in the field of power line networks. The invention has a number of aspects, which in one form, relate to a communication device and/or methods adapted for the automatic meter reading, data concentrator, home gateway, IR gateway and home automation, such as by way of example power point, light switches, curtain control, gas valve control, air conditioner & heater control, remote device and/or appliance control and/or industrial control markets. In a specific form, the invention and one or any combination of its aspects may reside in a power line modem.

### FIELD OF INVENTION

The present invention relates to communications devices and methods, particularly in the field of power line networks.

The invention has a number of aspects, which in one form, relate to a communication device and/or methods adapted for the automatic meter reading, data concentrator, home gateway, IR gateway and home automation, such as by way of example power point, light switches, curtain control, gas valve control, air conditioner & heater control, remote device and/or appliance control and/or industrial control markets. In a specific form, the invention and one or any combination of its aspects may reside in a power line modem.

It will be convenient to hereinafter describe the invention and its aspects in relation to a power line modem, however it should be appreciated that the present invention is not limited to that use only.

### BACKGROUND ART

The needs of today's consumers for information technology in their homes have dramatically increased over the last few years. People everywhere are dealing with a much greater volume of information than ever before and they need the capabilities to process it much faster.

The inventors have realised that one choice for construction of new houses is the installation of upgraded wiring while they have the chance during construction. Despite the fact that installing upgraded wiring in existing structures is generally considered cost-prohibitive, it is desirable to have home automation features, especially those that deal with communications, added to existing homes. There is a need to provide this in a relatively cost effective and simple manner.

Three types of products are currently available for retrofit home automation (HA) upgrades, namely power line communication (PLC), infrared, and radio frequency.

The inventors have realised that PLC technology may be utilised in Home Automation (HA) applications because it enables the installation of a control-oriented communication network without the need to tear down walls in order to install dedicated wiring. PLC is also considered less expensive than existing IR and RF solutions.

However, in many homes, electrical interference can prevent PLC receiver modules from operating properly. Electronic equipment found in virtually every household generates disruptive noise interference, such as TV's, VCR's, audio equipment, personal computers and peripherals, FAX machines, electronic lighting ballasts and many other electronic devices. There is also a need to provide PLC technology that alleviates problems associated with interference.

The inventors have also realised that PLC technology can be used in the AMR (Automatic Meter Reading) market from the point of view of utilities which are provided to the home. The utility meters market has been divided into three separate sectors, namely electricity, gas and water meters.

The electric utility industry is undergoing radical business and structural changes. With the unbundling of generation, distribution and transmission, as part of electric deregulation, utilities are closely examining many of their business processes. One of those areas currently being reviewed the most is meter data collection. With increasing demand for more frequent reading periods, electric utilities are looking for solutions that optimize their operations, improve service, lower costs, and provide additional services to their customers.

The water and gas utility industries are facing increasing pressure to do more with less. Water and gas utilities are being challenged to meet higher public expectations regarding drinking water quality, ways to control gas costs, security and safety issues with more stringent government regulations, while maintaining a high level of customer satisfaction and an efficient operation.

Today, many progressive electric, water and gas utilities are finding that implementing an Automatic Meter Reading (AMR) system can help position themselves better against today's and future challenges.

The inventors have further realised that there are several AMR communication technologies, namely Radio Frequency Communications, Telephone Line Reading, Broadband (Fibre/Coax Cable) and Power Line Communication (PLC). PLC uses the existing wires that deliver electricity to consumers as a communications link for AMR. This makes PLC AMR very attractive for AMR systems, especially for high density countries like China, India and most of Europe. The drawback of conventional PLC AMR is that signals may be easily affected by power line noise. The power cables were designed for distributing power but not necessarily for data applications as is needed in PLC technology.

In this regard, the inventors have identified that there are a number of specific problems, namely:

### 1. Noise

A power line is a very noisy environment. All sorts of noises exist not only in the amplitude domain but also in the form of phase distortion. During a mains power cycle the amount of noise can vary wildly. It is often the case that certain devices on the power line present different noise and loads at different parts of the cycle. This makes for an environment that is not only noisy but wildly dynamic. The time taken to transmit a packet can often be longer than many mains cycles. This means that the load and noise changes many times over the duration of a packet transmission.

### 2. Phase Detection

Often within the domain of power-line communications it is not always possible for a technician installing networks to determine which phase two nodes are using for communicating between each other. Phase information is either not labelled correctly or there is simply not the information easily available (eg accessibility to wiring diagrams for building). It is most often the case that between phase coupling is weak without some kind of extra added coupling at carrier frequencies. It is considered that in order to produce the best communications result it is advantageous for nodes that need to communicate to be on a similar phase. Phase detection is also very useful for trouble shooting.

### 3. Separated Solution

Prior art systems use what could be referred to as a ‘separated solution’. That is, there are several separate devices provided, namely a power line transceiver, a MCU, a non-volatile memory and some peripherals such as UART, SPI and RTC etc. This at least increases the cost of practically implementing a PLC system and maintaining or fault finding.

### 4. Signal to Noise Estimation

In the domain of power line communications a deterministic method of finding where the best point to point communication exists is needed. The noise on the power line is dynamic. A different time of day often produces a very different noise profile. It is almost useless to measure a noise profile only at the time of installation as the network may not communicate in an hours time due to the fluctuating noise. This is especially needed when determining where routers are to be placed. The inventors have realised that there is a need to be able to measure noise and signal strengths at anytime in such a dynamic environment.

### 6. Power Line Communications

A power line communications device with the indented use of low data rate communications and general control applications is needed. Domestic and commercial power lines are perhaps the most hostile environment for data communications. Devices connected to the mains network inject signals into the power line, which hinder the transmission of data. It is intended that the demodulation system will have to retrieve carrier frequencies in the presence of significant noise. Many of these noise sources are outlined in the EIA-709.2 standard document. In order for a power line communication device to function reliably it is considered that it should be able to exceed the specifications outlined in the standard. The inventors have realised that the main (but not the only) noise sources that effect demodulation are impulse noise, random noise and tonal noise. Random noise is considered one of the hardest to overcome in the context of receiving data.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

An object of the present invention is to provide an enhanced PLC technology, device and/or method of operation.

A further object of the present invention is to alleviate at least one disadvantage associated with the prior art.

### SUMMARY OF INVENTION

The present invention provides, in one aspect of invention, a method of, device and/or apparatus for transmitting data comprising the steps of providing a plurality of possible transmission frequencies, selecting one frequency from the plurality of possible frequencies, and transmitting the data using the selected one frequency.

The present invention also provides, in an aspect of invention, a method of, device and/or apparatus for determining the selection of a frequency for use in the transmission of data, the method comprising the steps of determining an estimate of band noise level, determining an estimate of received signal strength, and selecting a frequency based on the determination.

The present invention also provides, in another aspect of invention, a method of, device and/or apparatus for communication of data, the method comprising the steps of transmitting data based on a first characteristic, receiving the data, and retransmitting the data based on a second characteristic.

The present invention provides, in a further aspect of invention, a method of, device and/or apparatus for communicating data, the method comprising the steps of determining a zero level crossing of one phase of the power, determining a delay time, transmitting the data, on the rising edge, and delayed by the delay time from the zero crossing.

The present invention also provides, in a still further aspect of invention, a method of, device and/or apparatus for communicating data, the method comprising the steps of determining a level of noise, transmitting the data once the voltage exceeds the noise level.

The present invention also provides, in an aspect of invention, a method of, device and/or apparatus for providing error correction, the method comprising imposing reed-solomon error correction to at least some data received.

The present invention also provides, in an aspect of invention, a method of, device and/or apparatus for transmitting data, in a power line system, the method comprising the step of encrypting the data prior to transmitting the data.

The present invention also provides, in an aspect of invention, a method of, device and/or apparatus for determining if two nodes are coupled to the same phase, the method comprising the steps of forwarding a data packet to a selected node, the data packet including, at transmission, a first byte of data representing the phase of a transmitting node, receiving the packet at the selected node, determining the phase of the selected node at the time of receiving the packet, determining the difference between the first byte of data, and the selected node phase.

The present invention also provides, in an aspect of invention, a data packet adapted to be used in determining the phase difference between two nodes, the packet comprising first data representing the phase of the node transmitting the data, and second data representing the phase of the node receiving the data, at the time of receiving the packet.

The present invention also provides, in an aspect of invention, a method of, device and/or apparatus for determining phase change matching, the method comprising the steps of separating the amplitude and quadrature components of a signal, and comparing a phase change in a relatively noise-free carrier, with a relatively similar phase change in a carrier that has noise imposed on it.

The present invention also provides, in an aspect of invention, a method of, device and/or apparatus for bit synchronisation, in a power line system, the method comprising the step of using early-late synchronisation.

The present invention also provides, in an aspect of invention, a method of, device and/or apparatus for phase locking, comprising comparing the phase when it is determined that the phase is substantially stable.

The present invention also provides, in an aspect of invention, a substantially fully integratable power line communications device. The present invention also provides, in an aspect of invention, an interface device adapted of use in a power line system, comprising a low pass portion and high pass portion.

The present invention also provides, in an aspect of invention, a method of, device and/or apparatus for communicating, the method comprising the steps of addressing a message to a router node with a payload code and a final destination address pre-pended to the message payload.

In one embodiment, the present invention is used in a power line system.

Other aspects and preferred aspects are disclosed in the specification and/or defined in the appended claims, forming a part of the description of the invention.

The present invention has been found to result in a number of advantages, such as:
Combining an ANSI/EIA 709.1 compliant core with an ANSI/EIA 709.2 compliant power line transceiver into a single chip
CENELEC EN50065-1: 2001 compliant
8 programmable transmission frequencies dynamically selectable
Dual carrier frequencies
Forward Error Correction embedded
Very high tonal and impulse noise immunity
DSP techniques utilized
Integrates easily into existing EIA709.1 protocol compliant networks or create new EIA709.1 networks with STAPLM-300 alone
Efficient STAPLM-300 architecture allows reliable processing of network packets and application code
Standard GNU C interface for application code programming
Single 32-bit EISC processor for:
   Application code processing
   Event-driven task scheduler processing
   EIA709.1 protocol-firmware processing
Task specific hardware modules:
   Power Line Transceiver
   MAC Layer
   User configurable IO Interface
   Programmable Real Time Clock with battery backup
   Watch Dog Timer
   Reset and Clocking
   Two 16-bit Timer/Counters
ANSI/EIA 709.2 symbol rate support, 5.4 kbps at 131.98 kHz
−80 dBV receiver sensitivity
Ability to operate as a twisted pair transceiver.
Memory resources:
   On chip 96K Byte Flash for EIA709.1 protocol firmware, configuration data, application code and node specific information
   On chip 8K Byte RAM for buffering network and application data
Two embedded UART's
Embedded Low Voltage Detector
3.3V voltage supply with 5V tolerant 10
5×8-bit GPIO ports
Full Master/Slave SPI port
100-pin PQFP package
48-bit unique ID number in each chip
Industrial temperature range of −40° C. to 85° C.
Java based Node Developer software tool for application development
Any node may become a repeater through embedded routing mechanism

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates a system block diagram of an embodiment of the present invention implemented for Power Line Communication (PLC) user applications such as Automated Meter Reading (AMR) and Home Automation (HA),

FIG. 2 illustrates a block diagram of an embodiment of the present invention rendered on ASIC,

FIG. 3 illustrates a further block diagram representation of the ASIC,

FIG. 4a illustrates one embodiment of a receiver block diagram,

FIG. 4b illustrates one embodiment of a receiver and transceiver block diagram,

FIG. 4c illustrates a plot of the phase change matching counts for an alternating bit pattern and data,

FIG. 4d illustrates Simulation output showing the change in phase signal (delta-phase) and the bit synchronisation process,

FIG. 4e illustrates a bit synchronisation process,

FIG. 4f illustrates phase comparisons,

FIG. 5 illustrates one home automation system implementation of the present invention,

FIG. 6 illustrates an AMR system according to an aspect of invention,

FIG. 7 illustrates a block diagram of one embodiment of a transceiver according to an aspect of invention,

FIG. 8 illustrates a power line communication problem,

FIG. 9 illustrates the use of dual channels in accordance with an aspect of invention,

FIG. 10 illustrates a problem associated with high rise apartments,

FIG. 11 illustrates a counter operation,

FIG. 12 illustrates synchronisation,

FIG. 13 illustrates noise around zero crossing,

FIG. 14 shows how the phase counter relates to the mains cycle as well as the noise,

FIG. 15 shows how the packet mode system sends a packet but halts transmission around the distorted areas,

FIG. 16 illustrates the phase detection system in the context of a network,

FIG. 17 illustrates a prior art zero crossing detector system,

FIG. 18 illustrates phase detection according to an aspect of the present invention,

FIG. 19 demonstrates the relative counts between the phases,

FIG. 20 illustrates a frequency response for a filter network, in accordance with one embodiment of the present invention, and

FIG. 21 illustrates a schematic diagram of one embodiment of a circuit applicable to FIG. 20.

### DETAILED DESCRIPTION

### Overview

The present invention, in one embodiment is provided as a highly integrated System-on-a-chip (SoC) product. It combines a powerful Power Line Transceiver and control networking protocol firmware into a single chip. The SoC solution is considered to greatly reduce cost compared to other similar products, which require several chips.

The embedded power line transceiver is designed to operate in a harsh power line environment by utilizing modern DSP techniques to deliver reliable data communication. It preferably conforms to the ANSI/EIA 709.2 and CENELEC EN50065-1:2001 standards.

To produce enhanced performance, users have the option of selecting dual band transmission, various carrier frequencies, forward error correction, CENELEC Access Protocol, packet mode, data encryption and various transmitter output voltages. These options ensure the transceiver operates reliably in a noisy power line environment whilst also having the ability to conform to local regulations.

One embodiment of the present invention utilizes a 32-bit processor to process application code and network traffic. Its embedded protocol conforms to ANSI/EIA 709.1, the LonTalk® Control Network Protocol.

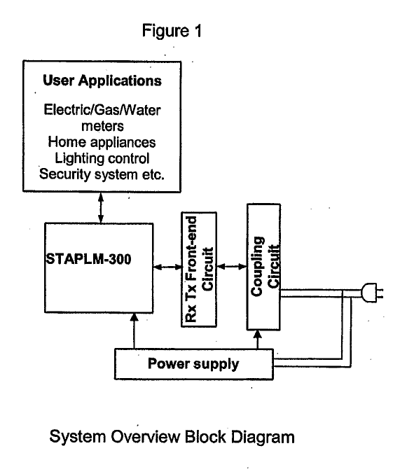

FIG. 1 illustrates one embodiment of the present invention which has been designed with an emphasis on Automated Meter Reading (AMR) applications where the low cost and high performance features are needed.

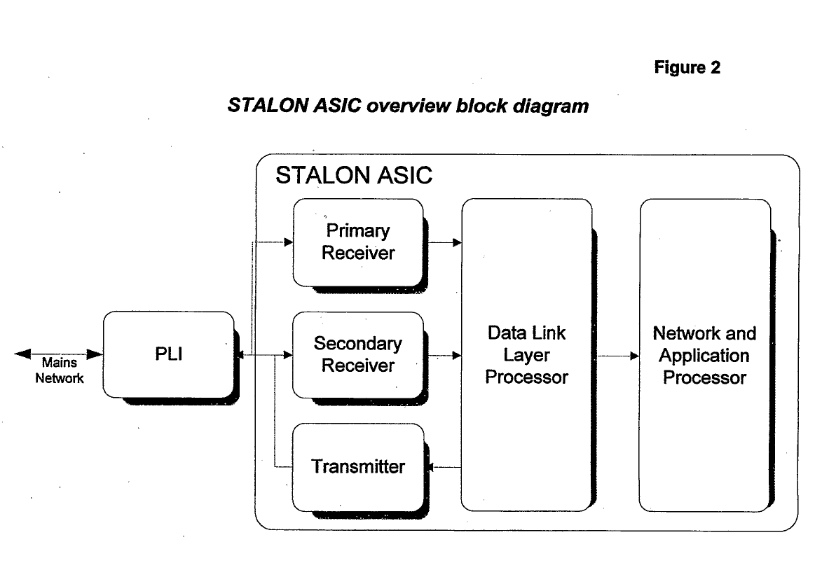

FIG. 2 illustrates a block diagram of an embodiment of the present invention rendered on ASIC. In the FIG. 2:
PLI—Power line interface: This is circuitry needed for the ASIC to interface with the mains power network.
Primary and Secondary Receivers—Described in more detail later herein. They are responsible for reliably taking transmitted signal from the power line network and changing it into digital data. There are two separate receivers (Primary and Secondary) this allows simultaneous receptions on different bands.
Transmitter—Is responsible for changing the digital data into a signal that can be transported across the power line network and reassembled at the receiver end.
DLL and Network processors—Responsible for interpreting the data and running the protocol stack.

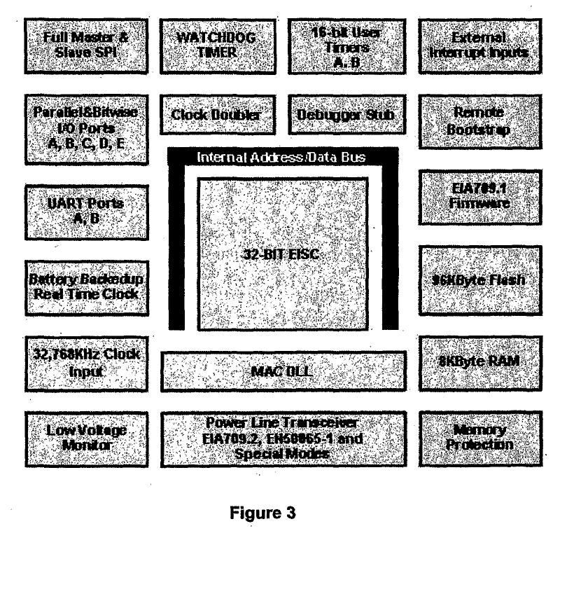

FIG. 3 illustrates a further block diagram representation of the ASIC. With regard to the block diagram:
Full Master & Slave SPI—Support full master and slave SPI (Serial Peripheral Interface) between STALON and other chips with SPI.
GPIO Ports—There are five 8-bit General Purpose Input/Output (GPIO) controllers. All of the ports are 3.3 volt, bi-directional and byte addressable. Each pin has an internal pull up resistor making the un-driven logic value of a pin ‘1’.
UART Ports—There are two full duplex asynchronous receiver/transmitters (UARTs). Their frame format is: 1 start bit, 8 data bits, no parity, and 1 stop bit. The baud rate is from 153 baud to 1.25M baud.
Battery Backed Real Time Clock—Is a 32-bit Real Time Clock (RTC). It has a battery backup in the case of a device power failure. In this mode it consumes less than 3□A from its backup battery.
32,768 KHz Clock Input—The Real Time Clock runs off of its own oscillator 32,768 KHz from the RTCClock Pin.
Low Voltage Monitor—There are two voltage monitors. One protects the device from logic errors caused by low voltage. It resets the logic in the device as well as the Phase Lock Loop. It trips between 2.7 and 3 volts. Another one is used to signal external devices of a low voltage failure, it controls the VDD_SENSE pin. This monitor switches between 1.2 and 1.3 volts, it will drive the VDD_SENSE pin from VDD to 0 volts. It has no impact on the internal chip.
Watchdog Timer—Is used to determine if the processor has stalled, and to recover from the stall.
16-bit User Timers—There are two 16-bit count down timers. Each timer can be set to count down to 0 or cyclic mode. Whenever a timer reaches its zero value an interrupt is generated.
Debugger Stub—GNU debugging stub.
32-bit EISC Processor—A 32-bit EISC (Extendable Instruction Set Computer) processor for:
   Application code processing
   Event-driven task scheduler processing
   EIA709.1 protocol firmware processing
MAC—Medium Access Control (MAC) Sub layer (Sub layer of layer 2), Outlined in EIA709.1 section 5 the MAC sub-layer provides an access protocol for the power line communication medium. The sub layer also provides compliance with the CENELEC standard EN 50065-1 signalling access protocol for the band of 125 kHz to 140 kHz (defined in section 5) standard.
DLL—Data Link Layer (Layer 2): Outlined in EIA709.1 section 6, the DLL is responsible for data error detection using CRC16 and interfacing to higher level layers situated in a control microprocessor which includes buffering between layers.
Power Line Transceiver—Physical Layer (Layer 1): Incorporates the whole EIA709.2 and CENELEC EN50065-1:2001 standards. It constitutes to the greatest complexity of the layers and incorporates the aspects of Power Line coupling, transmission power line drive circuitry, modulation, demodulation, data framing, simple error detection/correction and analog circuitry interfacing. It includes its special features like dual band transmission, various carrier frequencies, forward error correction, CENELEC Access Protocol, packet mode, data encryption and various transmitter output voltages. These advanced options ensure the transceiver operates reliably in a noisy power line environment whilst also having the ability to conform to local regulations.
External Interrupt Inputs—Selectable edge triggered interrupts.
Remote Bootstrap—Bootstrap via GNU debugger—using serial protocol.
EIA709.1 Firmware—The on chip Flash includes ANSI/EIA 709.1, the LonTalk® Control Network Protocol.
96 KByte Flash—On chip 96K Byte Flash for EIA709.1 protocol firmware, configuration data, application code and node specific information.
8 KByte RAM—On chip 8K Byte RAM for buffering network and application data.
Memory Protection—Memory violation interrupt triggered by illegal access to memory.

### One Example Implementation

The present invention utilises a layering configuration based on the EIA709 standard and the OSI layered model. The layering system is considered to be a logical and neat way of partitioning and implementing a communications protocol. In one embodiment, the layers are configured as:

| Layer No. | OSI Layer | Task |
|---|---|---|
| Layer 1 | Physical | Handles electrical specifications and modulation schemes |
| Layer 2 | Data Link | Data Encoding and Encryption, Frequency Selection, Data |
| | | Validity Checks, Collision Detection, Data Framing |
| Layer 3 | Network | Addressing |
| Layer 4 | Transport | Message Resending, Sending Acknowledgements, Duplicate |
| | | Detection |
| Layer 5 | Session | Request/Response Handling, Authentication |
| Layer 6 | Presentation | Command Interpretation: Determines if messages are for |
| | | Application Layer, Network Management, or Network |
| | | Variables. |
| Layer 7 | Application | Handles User Code and provides APIs |

A preferred embodiment of the present invention is a power line communications device with the intended use of low data rate communications and general control applications. The device incorporates a dynamic multi-band, multi-receiver transceiver, which is believed to be the first of its kind within the context of power line communications. The present invention was designed with the aim of flexibility in mind to alleviate some of the problems associated with power line communications. During the process of overcoming these obstacles many features were added. It is believed that these unique aspects include, but are not limited to, its frequency diversity and its ability to communicate on multiple channels simultaneously. Another aspect is the ability to measure the median channel characteristics in terms of its noise and signal strengths.

The demodulation system of the present invention will have to retrieve carrier frequencies in the presence of significant tonal interference and impulse noise as outlined in the EIA-709.2 standard document. Domestic and commercial power lines are perhaps the most hostile environment for data communications. Devices connected to the mains network inject signals into the power line, which hinder the transmission of data. Details are further described herein.

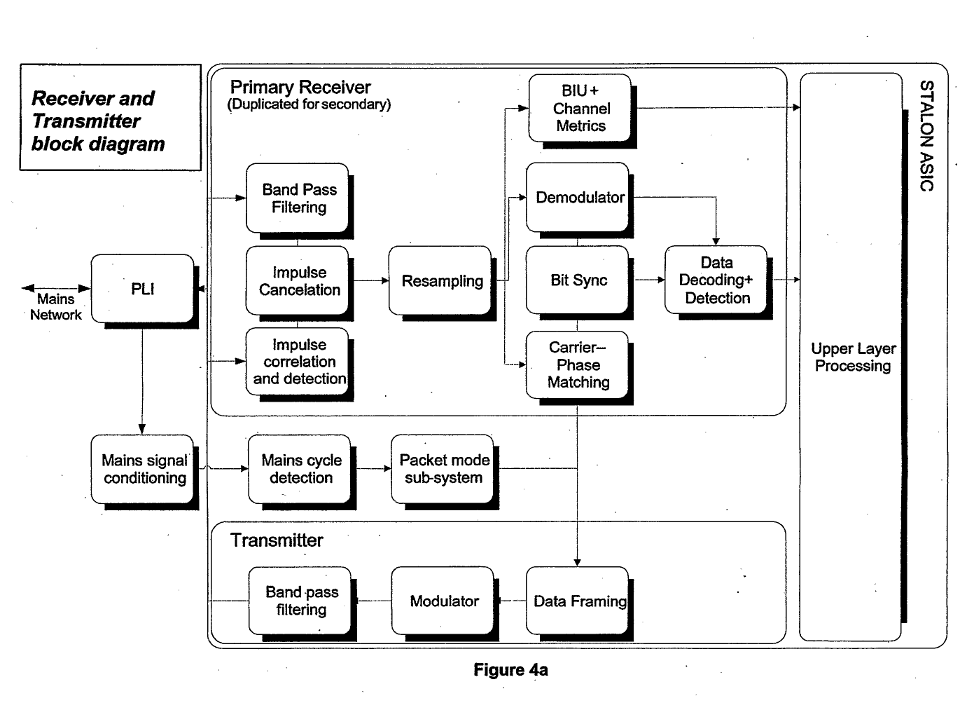

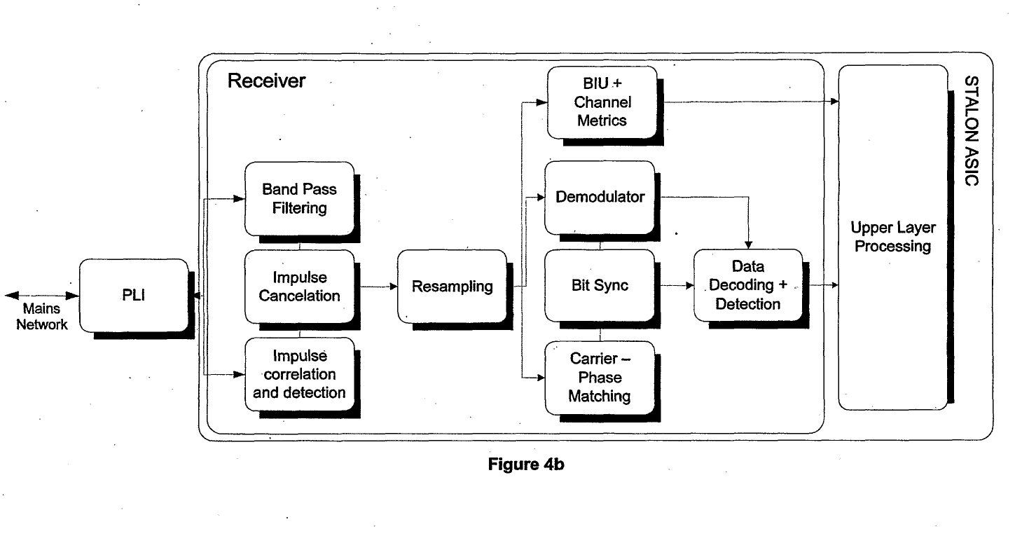

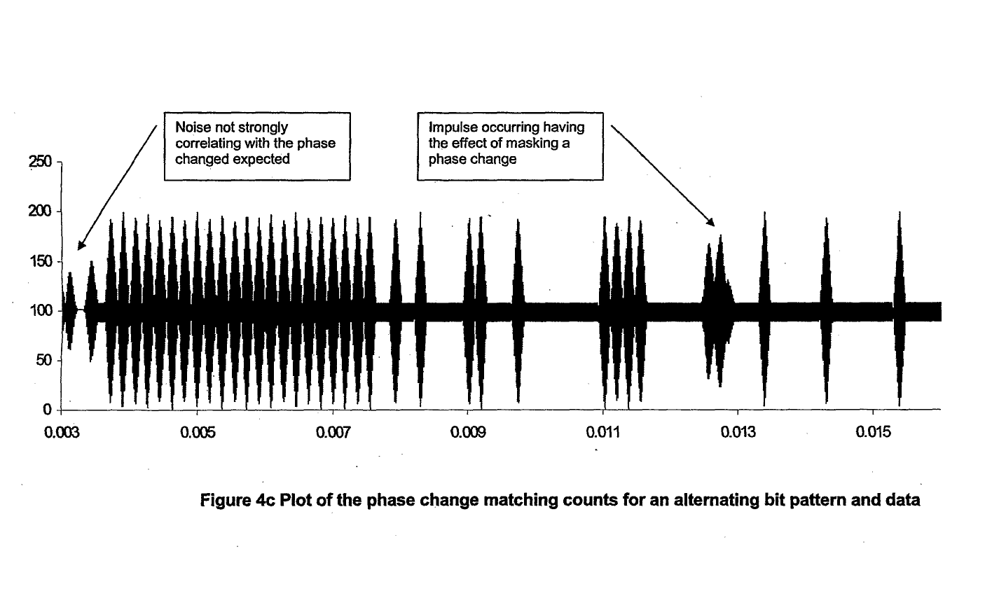

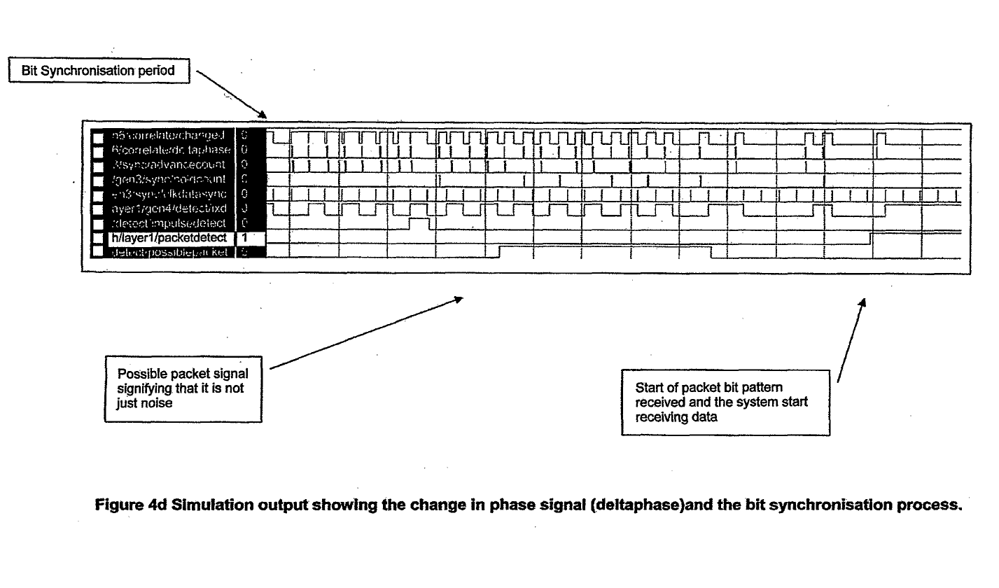

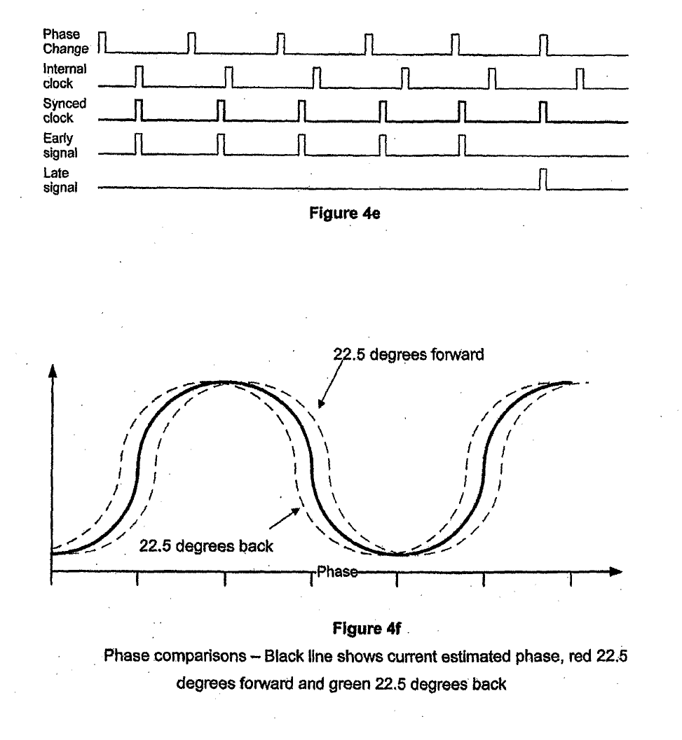

FIG. 4a illustrates one embodiment of a receiver and transceiver block diagram, in which:
PLI—Power line interface: This is circuitry needed for the ASIC to interface with the mains power network.

### Mains Cycle

Mains Signal Conditioning—Changes the mains signal from a high voltage down to a lower voltage, filters and clamps the signal ready to enter the STALON.
Mains cycle detection—A rising zero crossing is detected in this section. The zero crossing is then used to reset a counter that keeps track of the positioning of the mains cycle. This is used for phase detection and the packet mode system.
Packet mode sub-system—This system us used to avoid noise and is discussed in great deal in the packet mode patent application.

### Receiver

Band Pass Filtering—Very narrow filtering does not let signals outside the frequency range to use be used through. This enables rejection of noise on the power line network.
Impulse correlation and detection—this section searches within the signal coming in if there is an impulse present. Impulses are large transient voltages that have the effect of destroying the wanted signal. The impulse must be detected early in the system to have minimal effect.
Impulse cancellation—The impulse is preferably removed before it enters the system because it has the effect of drawing out impulses. As soon as an impulse is detected from the Impulse correlation and detection section the impulse is cancelled out from the band pass filter and the unaffected signal can enter the rest of the system.
Resampling—This aids the demodulation process.
BIU and channel metrics—This section provides the Band In Use signal to the MAC sub layer as well as providing channel metrics such as noise and signal strength to the upper layers.
Carrier—Phase Matching—Once the data has been resampled the phase of the signal must be acquired. This is done through a technique developed for STALON called phase Matching. It is considered a reliable method of determining the phase of a signal and also detects the position of bit boundaries in the signal. The bit boundary signal is passed onto the bit synchronization section.
Bit sync—The signal from the Phase Matching section is used to determine where the bit boundaries exist in the incoming signal. The bit sync does this by approximating every time it receives the signal and taking an average of them.
Demodulator—This takes the incoming signal and compares it to the reference phase that it has acquired. When the phase is compared it is able to determine the data that is coming through the receiver.
Data Decoding and Detection—The coming in is of a raw form. The data needs to firstly be checked for the start of packet bit sequence. Then the data needs to be framed and checked for parity. This framed data is sent to the high layers for extra processing such as CRC's and addressing.

### Transmitter

Data Framing—The data coming from the upper layer processor must be serialized and framed. This framing includes parity and polarity checks. The preamble, start and end of packet fields are also added to the packet.
Modulator—The modulator superimposes the serial data onto a carrier frequency in the form of BPSK. This enables the data to be transferred over the power line more reliably.
Band Pass Filtering—Very narrow filtering does not let signals outside the frequency range to use be used through. Make the signal as spectrally efficient as possible.

FIG. 4b illustrates one embodiment of a receiver block diagram. The receiver is specifically designed to combat the types of noise that are found on the power line medium. As described earlier the main types of noise that are found on the power line medium are:
Impulse noise: short duration “spike” of voltage and large in amplitude. The inventors have realised that this has the effect of dwarfing small signals also present on the medium. It is hard to reject and devastating to the demodulation if not rejected earlier in the receiver chain. Due to protocol one off impulses such as a light turning on will not cause problems to communications as the packet will be resent. Problem impulses are periodic in nature and mean that the probability of packets getting through will be low. The impulse has essentially the appearance of a phase change once it has passed through filtering etc, but does not correlate well with the expected waveform for a carrier phase change. The impulse also has the effect of distorting the phase changes making it harder to detect and therefore demodulate. An impulse on a phase change may effectively snub it and detection is weak. The impulse can be noted and accounted for in the particular position.
Tonal noise: Constant or bursting, periodic voltage. The inventors have realised that this often is caused by devices such as computers that contain switch mode power supplies. They place a tone of a specific frequency onto the power line. It is often varying in amplitude and can be very large in amplitude. Devices such as intercoms can also place tones on the power line that are also modulated. This modulation has the effect of hindering communications.
Random noise: Random noise is as the name describes ie. being non-deterministic in nature. The inventors have realised that it is hard to completely eliminate random noise because of its random nature. This form of noise after narrow filtering looks like extreme jitter in the carrier frequency. The effects of random noise can be minimized through averaging or other techniques. Average must be limited due to the effects of inter-symbol interference, so using simple techniques can only remove the noise to a point. Due to this the demodulation process must be very hardy against jitter.

The following description details aspects of invention which have been created to combat or at least ameliorate these types of noise listed above. The aspects may be included in the receiver as illustrated in FIG. 4b.

### Demodulation

### Carrier Phase Matching

Demodulating incoherent binary phase shift keying is considered to be a difficult process due to the lack of initial phase information. A reference phase must be found before demodulation can occur. The phase change matching or phase change correlation technique was developed (after considerable research) to be relatively reliable in the face of considerable jitter and other noise. Traditional techniques such as simple digital PLL based solutions are considered unreliable in the face of distorted carrier signals. Jitter and noise has the effect of making a PLL unable to lock and therefore unable to demodulate. This was considered unsuitable for the power line application and more signal conditioning would be needed in order to make these traditional techniques usable.

Initial research was carried out using the (so called) ‘integrate and dump’ technique, common in BPSK systems. It involves comparing the incoming carrier signal with the phase of an internal clock of the same frequency. The phase is compared over a bit period, incrementing a counter when the phase is the same and not incrementing the counter if they are different. The end accumulation is then compared with half of the maximum possible count to determine the phase of the carrier. This accumulation over the bit period has the effect of averaging and therefore makes demodulation less prone to noise. This technique has a number of foreseeable problems. Firstly the carrier and internal signals must be phase locked or a definite decision can not be made if the phase of the signal was not initially close to that of the internal clock. As previously mentioned phase locking is prone to noise problems and would require significant effort for it to be suitable. Secondly a way of bit syncing was also needed and it required another system to do partial demodulation in order to determine the bit boundaries. If bit syncing was not carried out, the dumping of the accumulated value could occur in the wrong position (e.g. in between a bit boundary) once again making the phase decision process inaccurate.

The present aspect of phase change matching was derived from a form of the Hilbert transformer, which splits out the amplitude and quadrature components of a signal. By observing a phase change in a relatively noise-free carrier, it is possible to detect a similar phase change in a carrier that has noise imposed on it by comparing the two. The present invention compares the noise free carrier that we expect and the in coming signal. The two are multiplied together to correlate them. If they correlate well then we will get a large number when multiplied. If the two correlate well, there has been a correct phase change. If they do not correlate well then there is no phase change. In the binary phase shift keying system the two states are defined by sine waves that are 180 degrees out of phase from each other as:

s₀(t)=A sin ω_{c}t and s₁(t)=A sin(ω_{c}t+π)=−A sin ω_{c}t where S₀ is a logic 0 and S₁ is a logic 1.

Thus, the function of the phase change matching system for continuous time can be defined as:

$$\begin{matrix}{H}_{0} ( t ) = {\int }_{0}^{T} \frac{\vert r ( t ) \vert - r ( t )}{2 r ( t )} \times \frac{\vert s ( t ) \vert - s ( t )}{2 s ( t )} \\ where s ( t ) = \{ \begin{matrix}A sin {ω}_{c} t & 0 \leq t \geq \frac{T}{2} \\ - A sin {ω}_{c} t & \frac{T}{2} < t \geq T\end{matrix}\end{matrix} \qquad equation 1$$

A decision must be made as to the point at which a correlation is sufficiently high to determine a phase change has occurred. This system is substantially immune to noise due to the fact that it is comparing a wanted signal over a longer period of time. This has the effect of averaging out jitter and other unwanted noise. FIG. 4c demonstrates the output of the phase change matching system when given a typical initial portion of a packet. At first until time 0.004 s there is noise on the line it creates small counts, as it does not match well with a phase change. The carrier is now received and the initial alternating bit pattern is displayed until 0.010 s where the data becomes the start of packet field. After the start of packet sequence has been detected the data is received until the end of packet sequence is detected. The framing and detection of bit patterns is handled by the data decoding and parity checking sub-section.

Each spike in the count values represents a strong correlation to the phase change that is required therefore signifying a phase change in the carrier. Decision circuitry is placed on the output of the system to determine the point at which output counts are sufficiently high to confidently say that a phase change has occurred. This is simply implemented as a comparator at ¾ of the maximum count. This value was chosen because the system when given a carrier frequency without a phase change will produce counts that can reach the % and ¾ marks and therefore anything higher is likely to be a phase change. The decision level can be change if excessive errors are produced due to incorrect phase change detection. There are also multiple thresholds available for determining the difference between a weak phase change and a strong one. This can be used in error correction in determining if a bit received is likely to be erroneous. Additional processing of this signal is needed to recover the data.

The output of the phase correlation system only tells us that a phase change has occurred. This phase change also signifies a change in the data and therefore data recovery can simply be the toggling of a binary signal when a phase change occurs. Another method is the dual correllator method used for demodulation. It is important that there is no DC offset at the point of demodulation due to the fact that the phase change matching system relies on the zero crossings of the incoming signal. After the threshold has been reached by the phase change matching count a signal is produces to signify the change in phase (delta-phase). This signal is used to toggle lock onto the phase of the carrier and is also used in the bit synchronisation phase discussed in the next section. In the example shown in FIG. 4d, an impulse was added at approximately time=0.0125 s to demonstrate its effect on demodulation. From the output of the simulation it is evident that the counts have not reached as high due to the signal not closely matching that of a phase change. It has the effect of masking a phase change and therefore missing data encoded on the carrier. The early impulse cancellation method was developed to overcome such an effect.

The phase change matching system is implemented in a similar way to an FIR filter. They are essentially the same as they are an averaging processes using the multiply and accumulate technique. During each demodulation cycle, these bits contained in the shift register are multiplied by an array containing the data representing an ideal phase change after filtering. As only the sign bits are used, the multiplication process is simply the adding of the two bits. These multiplied numbers are added together to form a count that is high if they match and low it they do not match. Serial addition is used to minimize the area of the logic used. This method is considered very efficient in logic area and is also very reliable for determining bit synchronization and also the phase of the carrier.

The phase change matching technique can be used as a very efficient way of demodulation and is also quite reliable as a demodulation technique however it was found with research that the dual correlator method of demodulation is also reliable and the two may be used together to provide a very robust demodulation system.

### Bit Synchronisation

The synchronisation of the internal clocks to the asynchronous data transfer is considered important to ensure the reliability of the decisions made on incoming data. If the clock edges were to occur at a similar time to the phase change signal, jitter would significantly affect the demodulated data output as phase changes might occur just before the clock on some cycles and just after on others. The header of the packet contains an alternating 1 and 0 pattern for 24 cycles, which has been designed specifically for bit synchronisation. The phase change matching stage outputs a change in phase signal (delta-phase) to produce a definite time at which a phase change occurred. Using the alternating 1 and 0 sequence of the packet header plus the delta-phase signal, the internal clock can be aligned with the asynchronous data. An early-late decision process is used to carry out the clock alignment. Early-late synchronisation works by looking for rising edges in both the internal clock and the output of the phase change matching process. If the internal clock occurred before the received phase change then the data was late and the internal data clock is advanced to compensate. The opposite occurs for the case when the phase change was early and the internal clock is stalled to compensate. The 24 cycles of the alternating bit period is more than sufficient to produce an accurate synchronisation. FIG. 4e illustrates this process.

The data decision process actually occurs on the falling edge of the internal synchronised clock (eg half cycle) instead of the leading edge (such as is shown in FIG. 4e). This is because it represents the longest time in both directions for the phase change circuitry to make a decision minimising the effect of jitter. Bit synchronisation only occurs while the line is active and until the start of packet field is detected. This is to stop the system from synchronising to phase changes that are non-periodic and therefore unsuitable for synchronisation. Also the synchronisation process must not occur during the data period or the internal data clock will be continually changing. FIG. 4d shows the bit synchronisation process in more detail on actual received data.

### Phase Locking

When the delta phase signal is asserted, it represents a time when the phase of the carrier was substantially stable and a particular phase angle. This technique is considered superior to other techniques due to the fact that it only acquires the phase of the carrier when it knows the carrier phase is stable and not when the phase is changing. Phase Lock Loops are continually hunting for the phase of the carrier, this is considered to make them unreliable as the actual phase is never found because it is always “fishing” for the phase. The phase change matching technique is a deterministic way of determining the phase and is very robust against jitter and other effects due to noise.

To actually recover the data, a technique similar to the dual correlator method may be used. The dual correlator method compares the incoming signal to two phases (sine and cosine). These two phases are multiplied by the incoming signal. The phase that correlates the strongest with the incoming signal is used to determine which is closest to actual phase. The two reference phases are then changed to more closely match the signal. This method still continuously “fishes” for the correct phase match. The method developed in the present invention is considered more deterministic as the phase is compared when it is known that the phase is substantially stable. The demodulation is carried out using a more accurate method compared with that of the sine and cosine. Due to the fact that we know when the delta phase signal is asserted, the phase is stable and we are close to a particular phase range, we can use a finer granularity of phase references to compare to. The demodulator contains two phase references one that is 22.5 degree ahead of the current phase estimate and one that is 22.5 degrees behind the phase estimate. These are multiplied by the incoming signal and the one of the two that correlates the strongest is chosen as the new phase estimate. This is illustrated in FIG. 4f.

This system ensures that the internal phase estimate tracks very closely that of the phase of the incoming signal. It is very robust in the face of jitter because it only attempts to track the phase when it is known that the phase is substantially stable instead of trying to continually track.

### Home Automation

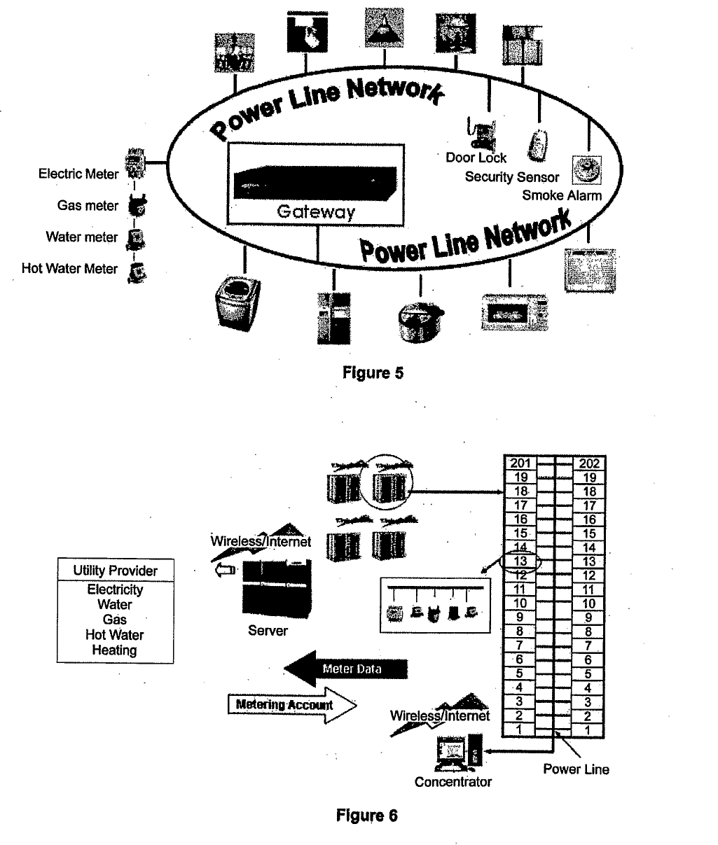

A typical HA system is illustrated in FIG. 5. The system contains a gateway to the internet. This gateway serves as a web host for the devices it controls and allows users to access the devices directly from the internet. Thus, the consumer can then easily control (e.g. switching on/off) lights or house appliances from anywhere with internet access (from either a PC or internet enabled TV).

The hardware for the gateway may simply be cheap device(s) such as a single board computer with Ethernet (e.g. Wildcat BL2000) or a Set Top Box with web hosting capabilities. The hardware may also be a more sophisticated device(s) or even a home PC for added functionality. Connection of the devices to the gateway can be achieved by either simply plugging an external Power Line Modem (PLM) unit (which is an aspect of the present invention) into a power outlet, or through the internal or integral PLM circuit embedded in one or more house appliances.

The PLM HA solution, in accordance with an aspect of the present invention is an open system. It is capable of interfacing easily with most of home appliances, hand-held computers, Set Top Boxes and PCs. Moreover, the PLM technology is considered to resolve difficulties associated with networking, OEMs can easily and rapidly design powerful products with the PLM technology. The PLM may include a set of powerful networking functions, relieving the designer from the low-level tedious networking details, and offering powerful networked-products to the end-user.

### Automatic Meter Reading (AMR)

There are several AMR communication technologies, i.e. Radio Frequency Communications, Telephone Line Reading, Broadband (Fibre/Coax Cable) and Power Line Communication (PLC).

PLC uses the existing wires that deliver electricity to consumers as a communications link for AMR. This is considered to make PLC very attractive for AMR systems, especially for high density countries like China, India and most of Europe. The drawback of conventional PLC AMR is that signals may be easily affected by power line noise. The power cables were obviously designed for distributing power not for data.

A power line transceiver, in accordance with an aspect of invention, is considered to make PLC AMR a reality. The unique dynamically changeable 8 frequency bands enable STAPLM-300 to choose the best channel for reliable communication under the noisy environment. More will be described later herein.

FIG. 6 illustrates one embodiment of a PLM AMR system in accordance with an aspect of invention. The PLM AMR system has at least the following main features:
Compatible to the open LON protocol, the de facto standard for AMR and control network. The protocol has the benefit of being flexible and proven in systems over the world. STALON can communicate with any devices using the same protocol. The protocol has also been utilised by the Italian nation wide AMR system currently containing 27 million meters.
Meets CENELEC EN50065-1 regulation for international operation. CENELEC conformance means that it is able to be used in many European countries.
High performance with features targeted at huge Asian market including lucrative Chinese market
Low cost with single chip solution
High noise immunity. For increased communications reliability.
High receive sensitivity. Increased communications reliability under high attenuation environments.
Build-in error correction. Ability to self correct errors in the face of extremely noisy conditions. Once again increases communication reliability.

Unique ID for each device. A Unique ID in each device means that every device can be individually addressed without complicated or inefficient addressing systems.
Assists in managing the grid, enhancing customer services, developing new pricing options and improving operations
Real time monitoring, control of the customer demand & load
Time & Money saving
Multi-tariff function. Each customer may be billed a different rate at different times of the day or week etc, to encourage power usage in times of lighter grid loading.
Faulty meter detection & recording. Faults with meters and in the grid are detected immediately providing prompt maintenance and customer service.
Increased packet success rate with built in smart repeater capabilities. Smart repeater function means that the transceiver is able to communicate over longer distances and more reliably.
Ability to control, configure and upgrade meters through network. The system has be ability to be dynamic. It can be configured to behave differently or its functions can also be changed or added by uploading and changing code over the power line network.
High data security with data encrypted DES encryption stops people reading and tampering with sensitive data that is transferred over a public medium.

Referring to FIG. 6, in the PLM AMR system, meter data is passed from the meter to a PLM node which is either integrated into or attached to the meter. From the power fine modem, data is transmitted over power lines to a concentrator. The concentrator may be an industrial PC or a single board computer with hard disk storage where the meter data is typically stored until a scheduled time, and then it is uploaded to the utility server by GSM, GPRS or Internet. The concentrator is not mandatory but is considered one way of implementing the present invention. It's inclusion depends on the application.

The STA-PLM AMR solution is a completely open system. It is capable to interface easily with other system components including meters, hand-held computers and management software.

### Industrial Control

The PLM in accordance with the present invention may be used in the industrial control market to monitor and control devices. It can be used in control switches, traffic lights, industrial automation systems and data monitoring devices to name a few.

An example of were PLM would be used in industrial control is a factory or business application. The PLM may be used to automate items such as conveyor belts, robot etc. Due to factories being electrically noisy environments and cables often have to be long due to the size of factories conventional communications such as Ethernet, wireless etc generally will not work. The present transceivers superior noise immunity and sensitivity make it ideal for industrial control.

Twisted Pair cables can also be used instead of power line cables for industrial control market. Twisted pair can be used in HA and is often used if wires are able to be laid easily. PLM can run on both media without changing the hardware and by using EIA709.2 protocol.

### Modem

One embodiment of the Power Line Modem technology is based on a highly integrated System-on-a-chip (SoC) product. It combines a powerful Power Line Transceiver, EIA709.1 control networking protocol firmware and ample embedded flash memory into a single chip. Other features and functions may also be provided. The SoC solution greatly reduces costs compared to other similar products, which require several chips.

The embedded power line transceiver is designed to operate in a harsh power line environment by utilizing modern DSP techniques to deliver reliable data communication. Preferably, it conforms to the ANSI/EIA 709.2 and CENELEC EN50065-1:2001 standards.

Preferably, to produce enhanced performance, users have the option of selecting dual band transmission, various carrier frequencies, forward error correction, CENELEC Access Protocol, packet mode, data encryption and various transmitter output voltages. These advanced options ensure the transceiver operates in a noisy power line environment whilst also having the ability to conform to local regulations.

STAPLM-300 preferably utilizes a 32-bit processor to process application code and network traffic. Preferably, its embedded protocol conforms to ANSI/EIA 709.1 control network protocol.

EIA709.1 protocol is a monitoring and control protocol. It is an “open standard” protocol that was developed by a US company named Echelon. The market for devices utilising this control protocol has grown substantially since the introduction of the first products in 1991. Approximately 54 million Echelon brand Neuron Chips had been shipped as of mid 2004, resulting in thousands of products using this open protocol in an impressive collection of applications worldwide. The EIA709.1 protocol provides a set of communication services that allow the application program in a device to send and receive messages from other devices over the network without needing to know the topology of the network or the names, addresses, or functions of other devices. Support for network management services allow for remote network management tools to interact with devices over the network, including reconfiguration of network addresses and parameters, downloading of application programs, reporting of network problems, and start/stop/reset of device application programs.

The PLM of the present invention is preferably compatible with the EIA709.1 protocol and all these of applications are interoperable with the PLM of the present invention.

STAPLM-300 has been designed with an emphasis on Automated Meter Reading (AMR) and Home Automation (HA) applications where the low cost and high performance features of STAPLM-300 are very attractive. However, the present invention may equally be adapted for use in other applications, such as Home Gateway, IR Gateway, Power Point, Light Switches, Curtain Control, Gas Valve Control, Air Conditioner & Heater Control and Any Control of Parameters, Sensor Interfaces, Robotic Control etc. in Industrial Automation.

Further more STAPLM-300 can also be used in industrial control application with twisted pair as transmission media as noted above.

The PLM according to this embodiment includes a number of features, such as:
Combining an ANSI/EIA 709.1 compatible core with an ANSI/EIA 709.2 compatible power line transceiver into a single chip
CENELEC EN50065-1: 2001 compliant
8 programmable transmission frequencies dynamically selectable
Dual carrier frequencies
Forward Error Correction embedded
Very high tonal and impulse noise immunity
DSP techniques utilized
Integrates easily into existing EIA709.1 compliant networks or create own networks with STAPLM-300 alone
Efficient STAPLM-300 architecture allows reliable processing of network packets and application code
Standard GNU C interface for application code programming
Single 32-bit EISC processor for:
   Application code processing
   Event-driven task scheduler processing
   EIA709.1 protocol firmware processing
Task specific hardware modules:
   Power Line Transceiver
   MAC Layer
   User configurable IO Interface
   Programmable Real Time Clock with battery backup
   Watch Dog Timer
   Reset and Clocking
   Two 16-bit Timer/Counters
ANSI/EIA 709.2 symbol rate support, 5.4 kbps at 131.98 kHz
−80 dBV receiver sensitivity
Ability to operate as a twisted pair transceiver.
Memory resources:
   On chip 96K Byte Flash for EIA709.1 protocol firmware, configuration data, application code and node specific information
   On chip 8K Byte RAM for buffering network and application data
Two embedded UART's
Embedded Low Voltage Detector
3.3V voltage supply with 5V tolerant IO
5×8-bit GPIO ports
Full Master/Slave SPI port
100-pin PQFP package
With EIA 709.2 symbol rate support, 5.4 kbps at 131.98 kHz.
48-bit unique ID number in each chip
Industrial temperature range of −40° C. to 85° C.
Java based Node Developer software tool for application development

### Power Line Transceiver

The embedded power line transceiver, in accordance with an aspect of invention, is designed to operate in a harsh power line environment by utilizing modern DSP techniques to deliver reliable data communication.

### Carrier Frequencies

The STAPLM-300 carrier frequencies are considered flexible giving the user control of the transmission spectrum without needing to change oscillator frequencies. Not only can the user choose between eight different carrier frequencies but they also can be controlled dynamically through software even on a packet-by-packet basis. This control can achieved in two ways:
1) The user can place a request over the power line for another node in the network to change the band it is operating on. This is done by placing a special network management packet out onto the power line addressed for the other node.
2) The user can change the local transceiver (eg itself) by calling a special software function that has the ability to change the bands. This function can be called just before a packet is sent to change the band in which the packet will be sent on. This is known as a packet by packet basis.

This paves the way for dynamic frequency allocation according to the communications medium conditions. The eight frequencies are located within the CENELEC A and C bands. The following table outlines an example of the available carrier frequencies and the corresponding data rates.

| | Frequency | Baud |
|---|---|---|
| Carrier | (KHz) | Rate (bps) |
| F0 | 131.578 | 5482 |
| F1 | 113.636 | 4735 |
| F2 | 104.166 | 4340 |
| F3 | 94.339 | 3931 |
| F4 | 86.206 | 3592 |
| F5 | 79.365 | 3307 |
| F6 | 73.529 | 3063 |
| F7 | 67.567 | 2815 |

In accordance with another aspect of invention, two communication frequencies can be received simultaneously when configured for dual band mode. The STAPLM-300 defaults to carrier frequencies of F0 and F1. Along with the communications medium metric estimation networks can dynamically determine the optimum communications frequencies to use for a particular installation. STA-PLMs can communicate with other EIA709.1 protocol based systems when either the F0 or F4 carriers are selected and all other relevant features are correctly configured.

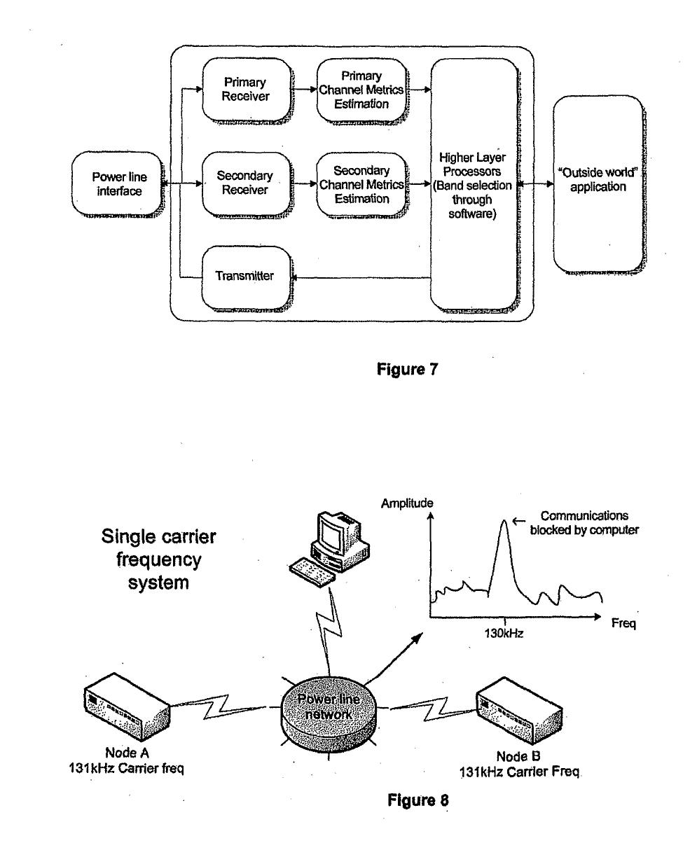

FIG. 7 shows a block diagram of a transceiver according to the present invention. With regard to FIG. 7;
PLI—Power line interface: This is circuitry needed for the ASIC to interface with the mains power network.
Primary and Secondary Receivers—Described in more detail later herein. They are responsible for reliably taking transmitted signal from the power line network and changing it into digital data. There are two separate receivers (Primary and Secondary) this allows simultaneous receptions on different bands.
Transmitter—Is responsible for changing the digital data into a signal that can be transported across the power line network and reassembled at the receiver end.
Noise and signal metrics estimation—Provides channel metrics such as noise and signal strength to the upper layers.
Higher Layer processors—Responsible for interpreting the data and running the protocol stack.
Outside world application—The way that the chip is used in a system eg for HA used as set top box power line interface.

The transceiver system contains many features that have been added to ease communications in the context of power line communications. It is identified that when communicating over the power line medium certain frequency bands provide more trouble-free transfer of data. A communications system that is unable to adapt to the environment around it is more often than not ineffective for data transfer. This is especially true in power line communications were the environment can change wildly and randomly. The present transceiver was designed with this philosophy in mind. Three aspects of the system were added to aid the process of environmental adaptability. These aspects are frequency diversity, Dual band receiver and channel metrics estimation, which will be described more fully below.

### Multi Band Frequency Diversity

An embodiment of the present invention has 8 possible carrier frequencies at which data communications can occur. More or fewer frequencies may be employed without departing from the spirit of this aspect of invention. For this embodiment, the follow table documents these 8 frequencies:

TABLE 1

| Band | Carrier Frequency (kHz) | Bit Rate |
|---|---|---|
| 1 | 131.57894 | 5482 |
| 2 | 113.63636 | 4735 |
| 3 | 104.16666 | 4340 |
| 4 | 94.33962 | 3931 |
| 5 | 86.20689 | 3592 |
| 6 | 79.36507 | 3307 |
| 7 | 73.52941 | 3064 |
| 8 | 67.56756 | 2815 |

The present invention has the ability to dynamically change these carrier frequencies on a packet by packet basis. This means that through software the receivers have the ability to be changed and not fixed to one frequency as the case with many other power line communication products. This frequency diversity has many benefits when in very noisy environments. The first of these benefits is that often on the power line medium various bands of frequencies are blocked by noise sources. Devices such as switchmode power supplies used in computers and television sets place noise on the power line that is largely tonal in nature providing communication difficulties at certain frequencies. FIG. 8 helps to illustrate this common problem.

When these communication difficulties are identified the present invention is able to dynamically change carrier frequencies in the field to avoid this particular noise source. It is often the case that the power line medium changes randomly from the last time communications were initiated. A simple case is somebody plugging in a computer which blocks the frequency at which communications were possible only a few minutes before. The dynamic aspects of the present invention go some way to overcoming these problems.

### Communication Medium Metrics Estimation

Each STAPLM-300 has the ability to estimate two communications medium metrics. These are how much noise is present in the communications band and the signal strength of each packet received. This allows a network to create more accurate decisions of where to put repeaters and routers and which frequencies to use. Also users are able to diagnose a network by looking at each nodes individual metrics. The metrics are based on a running average of the incoming signal after band limiting. Each of the metrics are in the form of a 16 bit integer that is able to be read either locally or from a remote node, allowing the whole network to share information.

Regarding the first metric, being an estimate of band noise level, whilst idle the PLM can acquire a 16-bit value which approximates the amount of noise that is presented to the node within the transmission frequency. This in band noise metric is the received idle noise level averaged over (say) 4 ms. It is recommended that multiple readings are taken and averaged once again due to the large fluctuations of noise commonly seen on power lines. Generally the less noise (e.g. the lower the acquired in band noise metric) the more reliable communications will be.

Regarding the second metric, being an estimate of received signal strength (RSSI), each packet received can be interrogated for its estimated signal strength. This is very useful to determine the signal to noise ratio of different nodes on the network. It may be that the noise in a particular band is low but the signal is also attenuated significantly making data transmission unreliable. Network management systems can also interrogate each node for signal to noise ratios to create a database of all transmission path conditions. This produces a deterministic way of finding where repeaters are needed in difficult environment even if they are dynamic.

### Dual Channel Mode

The STAPLM-300 has the ability to operate on two different carrier frequencies simultaneously. It is to be noted that the present invention may be configured to operate on more than 2 frequencies simply by providing more receivers, and still in accordance with this aspect of invention.

In a preferred embodiment, whilst transmitting you can only send data on one channel but you are able to receive on both channels at one (eg from two different nodes).

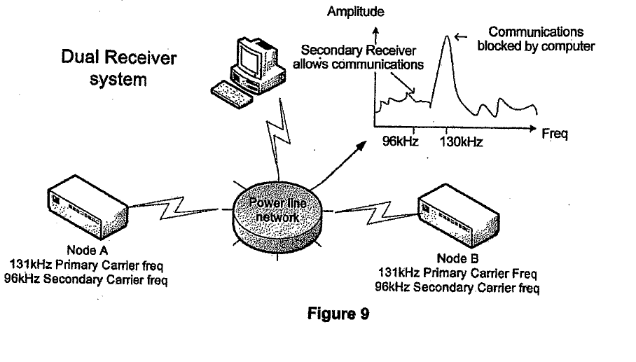

The Transceiver contains two receiver modules known as the Primary and secondary receivers. This dual receiver configuration gives the present invention the capability to communicate on two frequencies simultaneously. This opens up the possibility for many modes of operation that are beneficial in the context of power line communications. If a particular carrier frequency is blocked it may be impossible for a network to dynamically change carrier frequencies in a single receiver system. A network must still have communications in order to change each nodes carrier frequency to a common network frequency. The secondary band allows this. Acting as a redundancy channel, messages can be sent on the secondary band when the primary band fails. This gives the present invention the ability receive even when the primary is blocked by noise sources. FIG. 9 demonstrates the idea that when the primary channel of (for example) 131 kHz carrier frequency is blocked by an interference source such as a computer communications is still possible at the secondary channel of (for example) 96 kHz carrier frequency. The user can assign the primary and secondary channels any of the eight carrier frequencies that are defined in Table 1, above.

These two transmission frequencies can be used for a variety of applications. In the case of other EIA709.1 protocol based systems the secondary channel is superfluous and only used when communications on the primary are no longer possible. This could be due to particular devices on the power line jamming communications at the primary carrier frequency. With the dual channel mode enabled the last two retries of acknowledged service messages are sent using the secondary carrier frequency. This enables automatic enabling of the redundant carrier frequency in an attempt to finish the data transmission transaction. All PLMs that wish to communicate in this fashion have to be configured for the same carrier frequencies in order to make communications possible. A minimum of two retries must be used in this mode so that the first packet sent will be tried on the primary band and then the secondary band will be used. Dual channel mode can also be use in applications were common channel repeating is needed. Parts of a network can be segregated into different frequencies in order to effectively isolate the communication channels. PLMs may then be configured to repeat packets across the different carrier frequencies. The two carrier frequencies may be configured as any of the eight frequencies outlined in the carrier frequencies section.

### Dual Band Receiver Operation

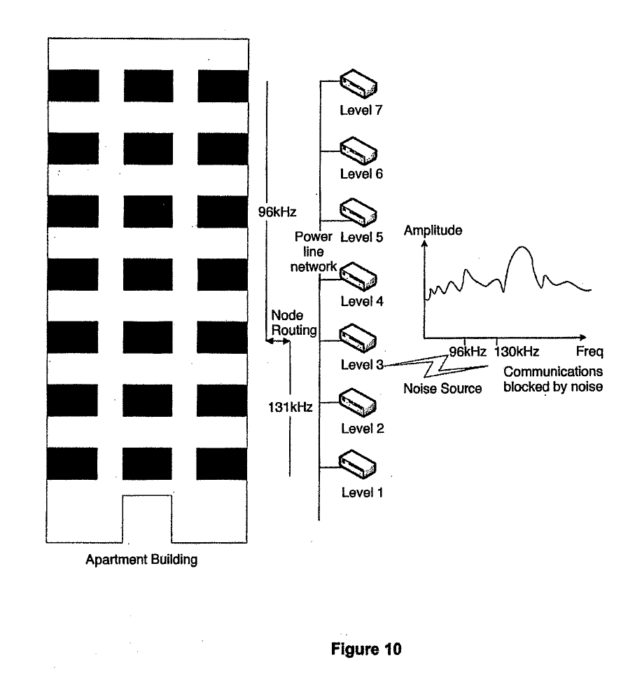

The concepts of frequency diversity and dual receiver also opens up the possibility of dynamic routing in difficult environments. Repeating on a common channel such as the power line creates problems if there is more than one repeater. Endless repeating is considered the result of poor placement of repeaters meaning that people deploying networks have to be very careful when installing repeaters. The dual receiver of the present invention means that a network can be segmented through frequencies to route rather than repeat. Each node also then has the ability to become a router without adding extra hardware in order to allow routing. FIG. 10 illustrates a common problem with meter reading systems in high rise apartment blocks. Communications from level 7 to level 1 is not always possible due to attenuation and a noise source that is located in the vicinity of level 3. A network can then be segmented into two channels to allow common medium repeating. A packet on (for example) the 96 kHz carrier will be received on level 3 from level 7. This packet will then be retransmitted on (for example) the 131 kHz carrier to level 1. More often than not there may be the need for more than one router/repeater due to noise sources on each level. This were the present invention has the advantage of dynamically changing where repeaters are placed and what frequencies are used even when the network is in operation. The channel metrics estimations are used in deciding where to put the repeaters and what bands are to be used. Each of the receivers has its own MAC layer in order to keep the channels completely discrete.

### Medium Access Protocol/CENELEC Access Protocol

The STAPLM-300 has selectable medium access protocols to keep it in line with local regulatory bodies. STAPLM-300 can be configured to use either the CENELEC or EIA709.1 access protocols. When CENELEC mode is selected it is compliant with the Access protocol outlined in the EN 50065-1:2001 standard, sub-clause 5. Maximum theoretical throughput is reduced whilst in this mode.

CENELEC outlines that every power line communications device must monitor the band from 131.5 kHz to 133.5 kHz and be able to detect the presence of a signal that is asserted for at least 4 ms and of at least 86 dBμVrms amplitude. A power line signalling device is permitted to transmit if the band-in-use (BIU) shows that the medium has been inactive for at least 85 milliseconds. Each device must then choose a random interval for transmission, and at least seven evenly distributed intervals must be available for random selection.

### Packet Mode

Packet Mode is a specially formulated data transfer mode that is designed to help avoid severe noise on the power line. STA-PLMs are able to sense when a large amount of noise is likely to occur and adjusts its transfer rate accordingly. When packet mode is enabled data throughput rate is lowered by approximately 30%. This mode can be dynamically enabled and disabled through software on secondary frequency band.

Perhaps the hardest noise to overcome is that of phase distortion. The system uses the modulation technique called Binary Phase Shift Keying (BPSK) to transfer data over the power line medium. It relies on the phase to determine what data being transferred. If the phase is being changed from an external method on the power line (eg by the changing of load impedances on the power line) then it can be virtually impossible to transfer a packet without erroneous data. The present invention contains a unique internal system that avoids points in the mains cycle where problems are likely to occur and which will the further described below. This reduces the likelihood of erroneous data being transferred in the harshest of environment.

### DEFINITIONS, ACRONYMS AND ABBREVIATIONS

PL Power Line
PLI Power Line Interface
Tx Transmit
Rx Receive
ASIC Application specific integrated circuit
SNR Signal to Noise Ratio
MAC Medium Access Control
Node A single end-point on the power line network that is capable of transmitting and receiving data.
BPSK Binary Phase Shift Keying
STALON Semiconductor Technologies Australian LON
STAPLM Semiconductor Technologies Australian Power Line Modem

Each node according to the present invention has the ability to sense the current position of the mains power 50/60 Hz cycle. This is done through a zero crossing sensor. The mains power is taken through an isolation device (either an opto-isolator or a step-down transformer) to produce a low voltage representation of the signal. This signal is given some basic analog low pass filtering to remove unwanted transients etc in the power supply that could falsely trigger the synchronization system. The signal is then clamped to GND and (for example) 3.3V rails to make sure that no damage could occur to the chip through transients and surges.

Once the signal enters the present invention, it is Schmitt triggered to stop the occurrence of meta-stability and introduce some hysteresis advantageous once again for filtering. Digital low pass filtering is then introduced to ensure that the zero crossing is not falsely detected. The filtering also guarantees the consistency of zero crossing point where any high frequency noise can cause jitter to the detection point any therefore giving inconsistent and inaccurate readings. The signal is then finally rising edge detected where it is used as a synchronisation signal throughout the present system.

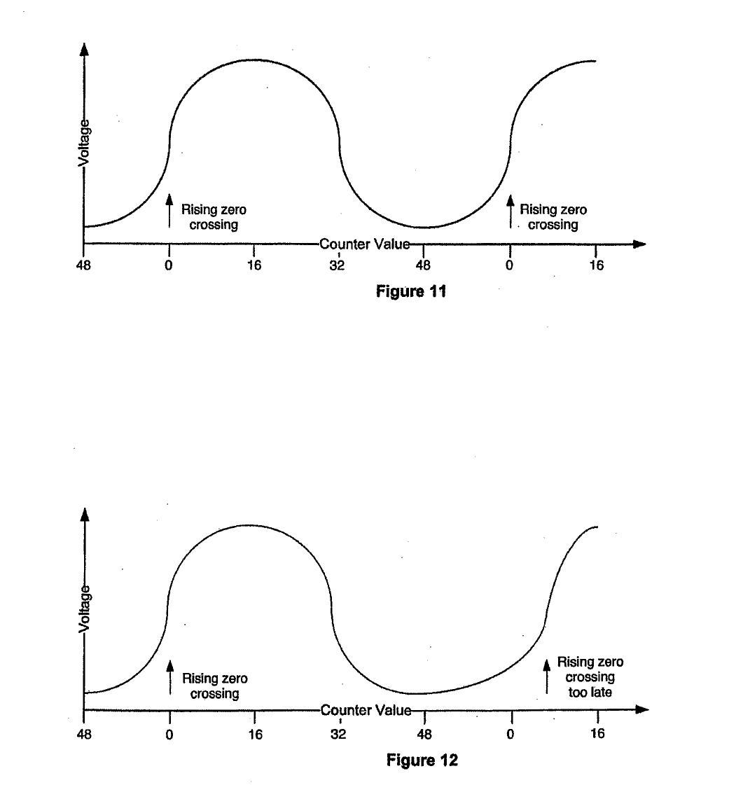

Each time a rising zero crossing has been detected an internal counter is reset as a reference to the phase (Phase counter). This counter has a fine granularity to ensure the counter free-runs until the next rising zero crossing is reached. It is important that it is a rising zero crossing and not simply just a zero crossing for reference reasons. FIG. 11 illustrates how the counter operates.

The frequency of operation is selected though software during the configuration of a node, Depending on where the node is being used either 50 or 60 Hz is selected. This mode selection determines the maximum count that can be reached for that frequency. This added in case small surges occur in the power and therefore the rising zero crossing is delayed. Using this condition synchronisation is maintained and the next rising zero crossing is ignored. This is illustrated in FIG. 12.

In some countries, such as Australia, the timing of the mains cycle is very accurate and therefore will almost always reset on the same count each time. In such countries the above mechanism may not be needed due to the consistent accuracy of the mains cycle. However the above mechanism is more relevant in countries where this consistency does not exist and therefore compromises reliability. This phase counter is used by many subsystems in the transceiver.

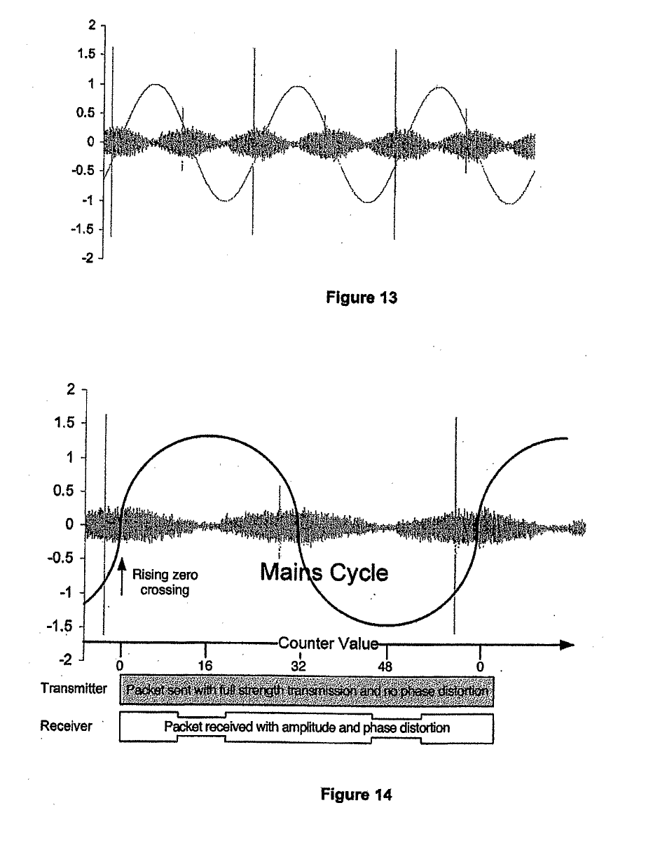

The noise contained on the power line is not constant. It is often changing dynamically according to the position of the mains cycle. Through research it has been found that often most of the noise is generated around the zero crossing point. FIG. 13 demonstrates this fact with some actual data acquired of the power line. (the thickened line is band limited noise, and the single line sine wave is the mains cycle position)

It can be seen that the noise swells as it gets closer to a zero crossing point. This is due to many loads on the power line conduct at the maxima and minima of the mains. This increased conduction loads down the noise on the power line and therefore it effectively seems quieter. This conduction also has the adverse effect of also attenuating signal as well as noise. Impulsive noise also occurs around the zero crossing point due to devices such as triacs being synchronous with the mains cycle. If there is high attenuation and significant impulsive noise present then it would be advantageous to avoid the part of the mains cycle that contains the most noise. This is how the packet mode system of the present invention works. The phase counter that is previously described is used to relatively accurately measure where the mains cycle is positioned at any time. This accurate sense mechanism allows us to avoid the noise on the power line network. FIG. 14 shows how the phase counter relates to the mains cycle as well as the noise.

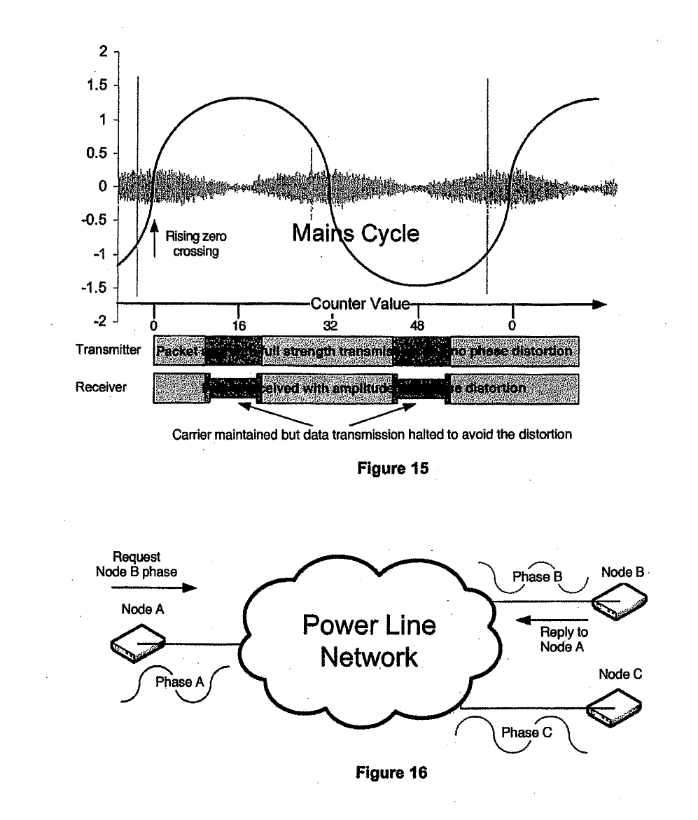

The bottom of FIG. 14 demonstrates how and where a packet will generally get distorted. As previously mentioned at the maxima and minima of the mains cycle amplitude and phase distortion is introduced to the carrier signal. From FIG. 14, it would be advantageous to avoid the areas where the distortion is introduced. This would be around the phase counts of 10 to 20 and 42 to 52. FIG. 15 shows how the packet mode system sends a packet but halts transmission around the distorted areas. The mode (and therefore the halting) is preferably enabled through software where a flag is set to enable the packet mode. The user sets the places where the packet is to be automatically halted. For example, in the above examples, phase counts 10 (start) and 20 (end) would be programmed into the configuration section of the chip. The halting will then occur in the 10 to 20 section.

### Error Correction Mode

Devastating noise on the power lines comes in many forms. Noise that is bursting or impulsive in nature can typically have the effect of destroying a whole byte of data. Most power line communication systems are unable to recover from such noise. If the noise is also repetitive in nature then communications may never normally be possible. When error correction mode is enabled a PLM has the ability to correct for multiple errors that would normally be unrecoverable in most other systems. When in this mode the data throughput rate is lowered by approximately 20%. Error correction can be enabled and disabled through software.

Preferably, the transceiver uses a error correction method that is known as reed-solomon error correction, although other error correction methods may be used in conjunction with the present invention. A special form of reed-solomon error correction is used due to the variable sized packets and to ensure the smallest sized packets. The most common variety of reed-solomon is called reed-solomon (255,223). This refers to there being a block of 255 bytes, 223 bytes are actual data and 32 bytes are what is known as the error correction syndromes. The correction syndromes are additional bytes use in the event of an error to correct it. This is considered wasteful because even if 10 bytes are sent then 32 bytes of syndromes need to be sent. The transceiver uses reed-solomon (11,15), this means it is based on a 15 byte block with 4 bytes of syndrome. This seeks to minimise the wastage. Also the syndromes may be spread throughout the packet rather than appended to the end of the packet. This is to minimise the effect of cyclic noise that is more than likely (in practice) to going to knock out 4 bytes in a row.

### Encryption Mode

The present invention, for example includes an integrated Triple DES encryption/decryption core. Due to the power line being an open medium any individual has the ability to read transmitted packets. There is even the possibility of intercepting packets, then manipulating data to falsify information. The strong encryption overcomes the problems of packet sniffing and manipulating data. Although the EIA709.1 protocol claims to have encryption it is not the case. It is simply uses a one way encoding of data that is very easy to decipher. The three encryption keys are stored through software and are field updateable to allow key rotation once significant amounts of data have been transferred.

### Variable BIU Threshold

The CENELEC EN50065-1: 2001 standard, sub-clause 5 specifies that the Band-In-Use threshold level is placed at amplitude of 86 dBμVrms. This level may not always be practical in many installations. Many environments contain noise levels that are in excess of this threshold level making reliable medium access impossible. It is for this reason that the present invention offers a variable Band-In-Use threshold to accommodate the ambient noise levels of a wide range of installations.

It is considered that if the BIU threshold is set close to the threshold of noise, it is possible that transmission may not be possible. This due to the system thinking that there is currently a packet being transmitted on the power line. In order not to collide with this “packet”, the transmitter will not proceed. To address this problem that exists in noisy environments, the threshold has the ability to be changed.

### Mains Synchronization

When the ACSYNC pin is connected in the correct manner a STA-PLM is able to synchronise to the phase of the AC power. Mains synchronisation can help in overcoming certain sources of noise on the power lines by transmitting at a user defined point of the AC power cycle.

### Phase Detection

The present invention has the ability to detect if two nodes are connected to the same phase. The present invention is able to provide the relative phase angle difference between the two nodes. The sensor (ACSYNC pin) may be connected as shown in the mains synchronisation configuration setting. The node may send a phase detection packet addressed to a particular known node. The remote node will then respond with the relative phase. This can be used in the field, as often in installations we are unable to ascertain if two power lines are on the same phase. Inter-phase communications are often difficult due to the large amounts of attenuation across phase couplings. During installation it is considered to be almost always best to communicate on the same phase.

The present invention offers a phase detection system inbuilt into every chip. This means that no special equipment is needed in the installation of a network according to the present invention to determine a phase difference between nodes. Technicians need not even be called out to the site to see if the phases have been wired up correctly as they can be diagnosed remotely.

The phase detection mechanism has addressing information embedded into the system in order to create point to point readings rather than having to remove all other nodes from the network. FIG. 16 below illustrates the phase detection system in the context of a network.

### DEFINITIONS, ACRONYMS AND ABBREVIATIONS

PL Power Line
PLI Power Line Interface
Tx Transmit
Rx Receive
ASIC Application specific integrated circuit
SNR Signal to Noise Ratio
MAC Medium Access Control
Node A single end-point on the power line network that is capable of transmitting and receiving data.

Each node has the ability to sense the current position of the mains power 50/60 Hz cycle. This is done through a zero crossing sensor on (for example) the ACsync pin, and an example of this is described above in relation to the “Packet Mode”.

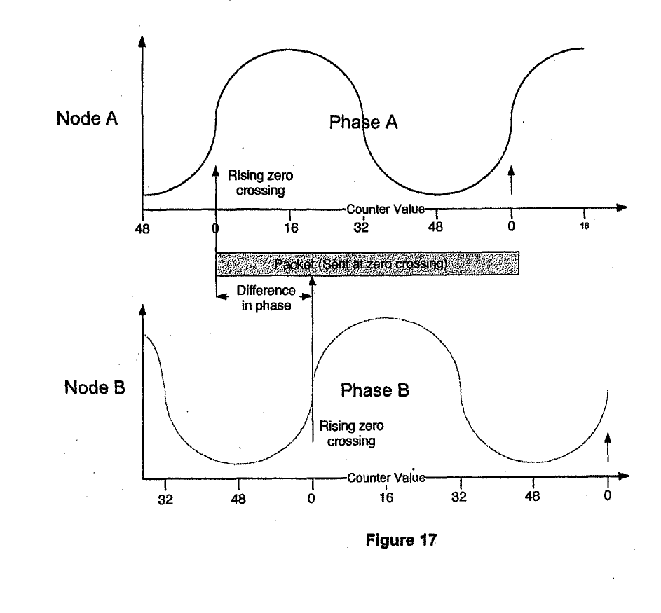

The traditional detection system consist of transmitting on a zero crossing and measuring the time that elapses since the last zero crossing. This is illustrated in FIG. 17.

Although the traditional method is simple, it has a problem in the fact that it breaks the medium access algorithm. This algorithm is specified in the EIA709.2 and CENELEC standards. It basically says that if there is a presence of a carrier on the power line then you are not allowed to transmit as it would cause a collision. The traditional method breaks this algorithm because it transmits at a specific point in time regardless of whether there is a packet being transmitted. This is considered to have the shortcoming of causing collisions on the common power line medium within a network that is already commissioned. The present phase detection system is considered unique as it does not affect the medium access.

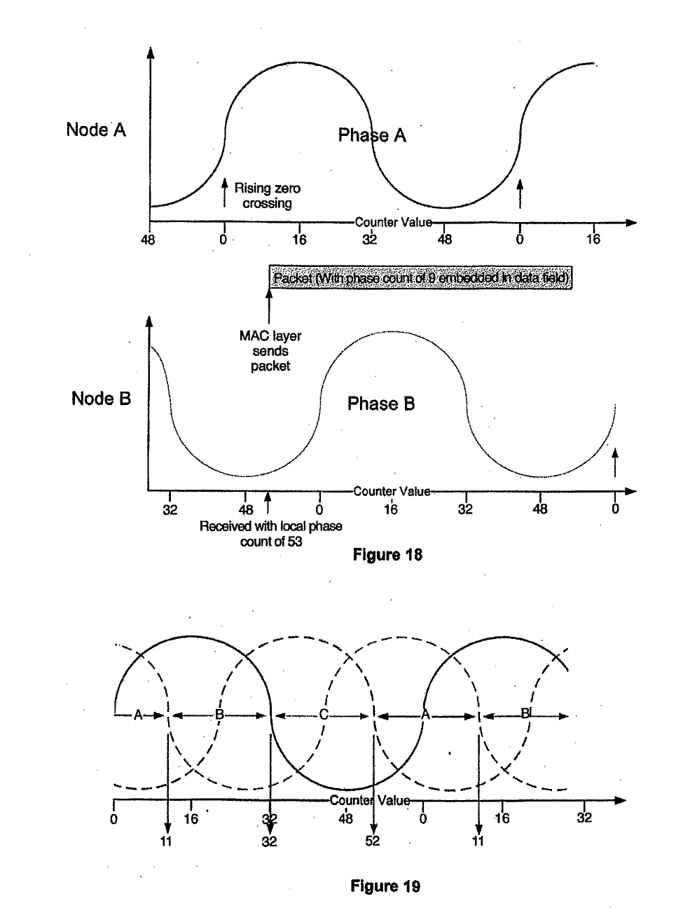

It operates in the following fashion. A phase detection packet is commissioned from the application layer. It is addressed to a particular node in which the relative phase difference is to be determined. This passed onto the medium access control (MAC) sublayer where it waits for the next transmission slot. Once the MAC sublayer has given the signal to transmit the packet is assembled at that time at the physical layer. Two bytes of the data field of the packet are reserved. The current phase counter is placed into these reserved bytes of the packet and the rest of the data untouched. When this packet is received by the addressed node the phase count at the time of reception is acquired and stored with the packet. The phase difference is then calculated according to the discrepancy between the phase count embedded in the packet and the phase count when the packet was received. FIG. 18 illustrates this.

There is a small amount of delay before the receiver acknowledges that the start of packet field has been reached. This delay is relatively constant and accounted for by simply subtracting the delay from the phase count. Due to there being only three possible phases in power line transmission networks, there are three ranges of relative phase counts. FIG. 19 demonstrates the relative counts between the phases when referenced to phase A.

As it can be seen a relative count of 53 to 11 signifies that it is the same phase. A relative count of 12 to 32 signifies that it is 120 degrees out of phase and 33 to 52 signifies 240 degrees out of phase.

It can be seen that this method does not affect the medium access algorithm therefore making it useful to a network that has already been commissioned and running in the field.

### Twisted Pair Operation

Although the STAPLM-300 is designed for power line networks it also has the ability to provide excellent communications over twisted pair networks. Due to the high sensitivity of the receiver, communications over large distances is possible. This is ideal for buildings that have existing twisted pair or wired communications.

When STAPLM-300 is supplied with a back up battery, it able to transmit over the same power line cable even when the power goes off, as if it was a twisted pair.

### Integratable

The present invention is substantially fully integratable. Aside from new technologies introduced, the present invention, implemented on chip is designed to fully conform to the open standard LONWORKS (EIA709.1 protocol) power line communications protocol. It can be fully integrated with any other devices using the same protocol. Therefore, it can inter-operate with devices existing in a product or network.

### Lonworks Interoperability

In its most basic mode STAPLM-300 nodes are compatible with other LonWorks® (EIA709.1 protocol) based systems and all other EIA709.2 compatible devices. Error correction, packet mode and encryption must be turned off in order to enable communications from other LonWorks® based systems. Also as other LonWorks® based nodes can only receive and transmit on 132 kHz and 86 kHz carrier frequencies using the EIA709.2 protocol these frequencies must also be selected to enable interoperability.

The high integration (low system cost) and powerful power line transceiver make the STA-PLM is the winner of using power line for Automatic Meter Reading (AMR) and Home Automation (HA).

### Power Line Interface Circuit

The STAPLM-300 Power Line Interface Module consists of all of the necessary circuitry to interface the digital ASIC to the analogue power line.

In one embodiment, the analog front end contains two sections comprising of a low pass and high pass component. It is specifically designed to have a small impulse response and wide pass-band to incorporate all the carrier frequencies that the present invention operates at. It also must act as an anti-aliasing filter to reject any frequencies above the niquist rate for the sampling frequency. Also importantly, in one application, is the fact that it operates as a filter for rejecting strong tonal noise outside the carrier frequency bands.

Specified in the EIA 709.2 standard is a recommended tonal rejection profile. The profile is based on some of the common tonal noise found on the power line. This is namely devices such as intercoms above 150 kHz and switch mode power supplies in the lower ranges. It has also been determined that there is often more actual noise on the power line than what is ideally stated in the applicable standards. This shows that many devices operating on the power are not conforming within their applicable standard ranges. With this in mind the front end was designed to cope with interference that exceed the maximum disturbance limits outlined in the standards so that it was more able to operate in a real environment. A second order sallen-key filter structure was used for its unity gain, stability and its ability to be used in a single power rail system. The filter provides a second order band pass function. It is chosen as the best trade of between cost, performance and complexity.

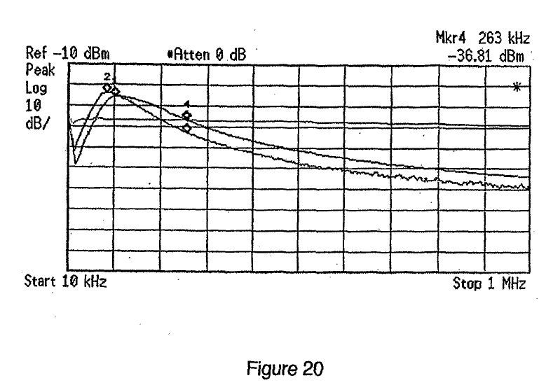

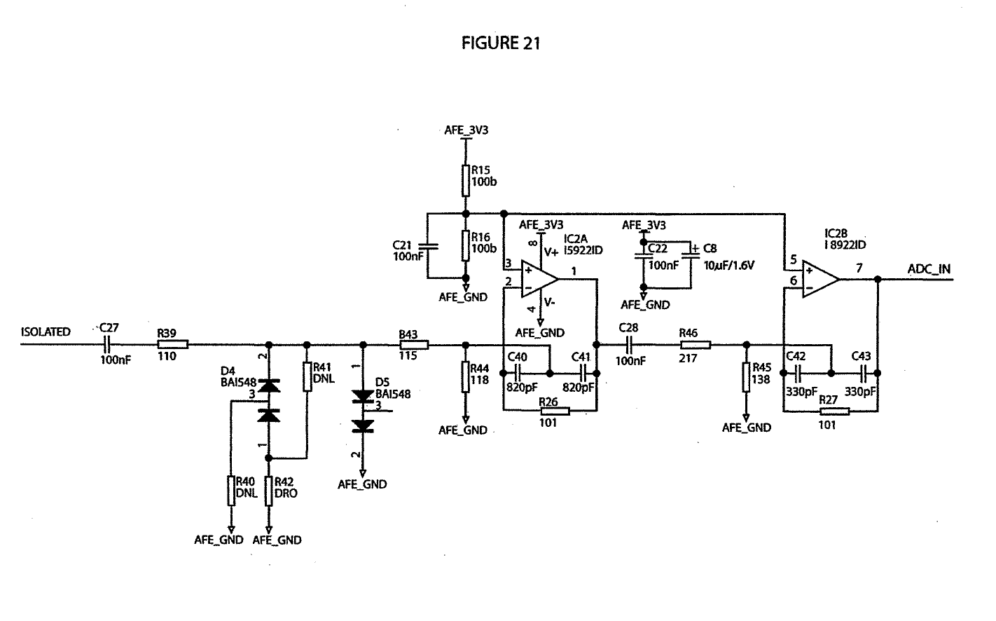

FIG. 20 shows the frequency response for filter network, in accordance with one preferred embodiment of the present invention. The −3 dB points are placed at approximately 65 kHz and 140 kHz. This is to ensure that all carrier frequencies are not attenuated by the filter but at the same time attenuating noise as much as possible. The frequency response is also easily modified, with only two components needed to change. This is advantageous when only certain frequency bands will be used. The filter can be narrowed to increase tonal noise rejection. The analog front end also adds a DC offset that is needed for the ADC to operate correctly. The schematic diagram is show in FIG. 21.

### Routing

The inventors have realised that a STAPLM-300 node may not be able to communicate directly with another node at all times due to reasons of noise, interference, and signal attenuation. Because of this, it is sometimes necessary for nodes to communicate indirectly.

It is preferred that every (or at least some) devices of the present invention (STAPLM-300) can act as a router, routing is implemented as a Network Management command. A message is addressed to the router node with a payload code of STALON_NM_STALON_ROUTE (0x7E) and the final destination address information pre-pended to the message payload, the router then forwards the enclosed packet to the destination. Because the routing is implemented in the Application, it can be dynamically switched on and off as network conditions change.

When a router node receives a route message it strips the route information from the start of the message and forwards the result to the destination node. The destination node will see the incoming message as having been generated by the router. If the destination node responds the response will be directed to the router node's address. The router node then forwards the response to the initiator node. When responses are returned by the destination they arrive at the initiator node with the router node's address.

If a routing node cannot contact its destination, it returns the code STALON_NM_STALON_ROUTE used to initiate the route. This tells the initiator that the transaction failure was due to communications difficulties between router and destination, and not between the initiator and router.

Routes may be nested (i.e. a message can be routed through a number of nodes before it reaches the destination). To add an extra route to an outgoing message simply pre-pend another route request in front of any existing ones.

### Example of a Route

Three nodes A, B, and C:

A can communicate with B.

B can communicate with A.

B can communicate with C.

C can communicate with B.

A cannot communicate with C.

C cannot communicate with A.

Node A can forward a message from B to C, the message response (if any) will return via B to A.

### Routing Issues

Because a route increases the packet size, it will impact on the maximum size the user can make a packet.

Routing will produce extra network traffic (each stage of the route increases congestion to forward a message) and an increased response time (the routed packed takes longer to reach the destination and the response takes longer to return). Care must be taken to tune the retry timing of each stage. If a node retries too frequently the retries can collide with the response packets from the router.

### Route Example

The following example shows a scenario where the initiator wants to send a sub-net node addressed message to an unreachable node. The payload to be delivered is a code of 0x20 and data of 0x10. A router node is chosen it contains the address of the unreachable destination in its address table at table index 1.

Destination Address (in raw bytes): 0x01 0x00 0x44 0x44 0x05
Route Address1 (in raw bytes): 0x01 0x02 0x44 0x44 0x05

| | | |
|---|---|---|
| Address | Payload Code | Payload Data |

Original Packet (No Routing)

| | | |
|---|---|---|
| 0x01 0x00 0x44 0x44 0x05 | 0x20 | 0x10 |

Routed Packet (If Address Index Supplied)

| | | |
|---|---|---|
| 0x01 0x02 0x44 0x44 0x05 | 0x7E | 0x01 0x20 0x10 |

Routed Packet (If Full Address Supplied)

| | | |
|---|---|---|
| 0x01 0x02 0x44 0x05 | 0x7E | 0x0F 0x01 0x00 0x44 |
| | | 0x44 0x05 0x20 0x10 |

### Asynchronous Receiver/Transmitter (UART)

There are two full duplex asynchronous receiver/transmitters (UART's) in the STAPLM-300. They support baud rates from 1.25 mega baud down to 300 baud. The frame format is: 1 start bit, 8 data bits, no parity, and 1 stop bit. Each UART can generate a receive buffer full or transmit buffer empty interrupt.

### Hardware Timers

There are two 16-bit count down timers, they can each generate an interrupt. The timers have a 50 ns time base.

There are pre-scale settings for modifying the default time base. The pre scale settings can be from a one ms pre-scalar, the Real Time Clock Unit, or the UART baud rate timer.

The timers can be set up to count interrupts from a GPIO Port, or from the other timer. The timers can be set to cyclic mode, where they automatically reload, making them useful for periodic timing functions.

### GPIO

There are five 8-bit General Purpose Input/Output (GPIO) ports in the STAPLM-300. They are labelled A through to E. All of the ports are 3.3V, 5V tolerant, bi-directional and bit addressable. Bit 0 for each port can be used as a level sensitive interrupt input, the interrupt polarity is programmable.

Port E's pins may be used for hardware specific operations: Amplitude Shift Keying, Serial Shifted Output, SPI, and Real Time Clock calibration.

### Amplitude Shift Key Unit

This controller will modulate input generated by GPIO Port E, or from the UART transmit pin with a carrier generated by one of the user timers. This unit is useful for activities like infra Red communications.

### Serial Shift Output

This is a buffered timer driven output. The output updates exactly at the timer rate. This produces a high precision for timing/phase sensitive applications.

Without buffered timer driven output the microprocessor execution time is added to the phase error (jitter) of the pin, this phase error will be many orders of magnitude greater than the latent error in the input clock.

### SPI Input/Output

Pins can be configured as the Serial Peripheral Interface (SPI) port. STAPLM-300 includes a full Master/Slave SPI module with following features:
a Master or slave mode
Multi-master bus contention detection and interrupt
Four transfer protocols available with selectable clock polarity and clock phase
Variable length of transfer word up to 16 bits
Is compatible with SPI (a trademark of Motorola Semiconductor) and Microwire/Plus (a trademark of National Semiconductor)
Bit rates generated in Master mode: ÷2 down to ÷256 of System clock
Bit rates supported in Slave mode: SCK=System clock÷4

### Break Point Register

Whenever the microprocessor program counter equals this register, a breakpoint interrupt is generated. This register is used by the GNU debugger.

### Watch Dog Timer

This timer can have a period between 1 ms and 2 sec. It can be configured to generate an interrupt or to reset the STAPLM-300.

### Interrupt Controller

All interrupts may be blocked, cleared or set in software. The interrupts are buffered in the event of a new interrupt being generated while an existing interrupt is being handled. The interrupts include: UART buffer interrupts, SPI interrupts, GPIO interrupts, Timer interrupts, a Real Time Clock alarm interrupt, a watchdog interrupt, and a break point interrupt.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A method of transmitting data comprising the steps of
providing a plurality of possible transmission frequencies,
selecting one frequency from the plurality of possible frequencies, and
transmitting the data using the selected one frequency.

2. A method as claimed in claim 1, wherein the selection of the frequency for transmission is based on a measurement of noise in the system.

3. A method as claimed in claim 1, wherein the selection of a frequency is based, at least in part, on a frequency which has a relatively low level of noise.

4. A method as claimed in claim 1, comprising the further step of transmitting the data or further at the one frequency or another frequency selected from the plurality of frequencies.

5. A method as claimed in claim 1, further comprising the step of transmitting the data at a plurality of frequencies simultaneously, the frequencies being selected from the possible frequencies.

6. A method of as claimed in claim 3, wherein the low level of noise is measured based on the idle noise level over a period of time.

7. A method as claimed in claim 6, wherein the period of time is at least 2 msec.

8. A power line communication system comprising:
means for providing a plurality of possible frequencies, and
transmitting means adapted to transmit data using a selected one of the plurality of possible frequencies.

9. A system as claimed in claim 8, wherein the transmission of data is at a frequency selected based on a measurement of noise.

10. A method of determining the selection of a frequency for use in the transmission of data, the method comprising the steps of:
determining an estimate of band noise level,
determining an estimate of received signal strength, and
selecting a frequency based on the determination.

11. A method as claimed in claim 10, wherein the selection of frequency is based on a relatively low noise level, and relatively high signal strength.

12. A method as claimed in claim 10, wherein more than one frequency is selected.

13. A method of communication data, the method comprising the steps of:
transmitting data based on a first characteristic, and
receiving the data, and retransmitting the data based on a second characteristic.

14. A method as claimed in claim 13, wherein the first or second characteristic is a frequency.

15. A method as claimed in claim 13, wherein the first or second characteristic is an address.

16. A method of communicating data, the method comprising the steps of:
determining a zero level crossing of one phase of the power,
determining a delay time, and
transmitting the data, on the rising edge, and delayed by the delay time from the zero crossing.

17. A method of communicating data, the method comprising the steps of:
determining a level of noise, and
transmitting the data once the voltage exceeds the noise level.

18. A method as claimed in claim 17, wherein transmitting the data occurs on a rising edge of the power cycle.

19. A method of providing error correction, the method comprising imposing reed-solomon error correction to at least some data received.

20. A method as claimed in claim 19, wherein the error correction is reed-solomon (255,223).

21. A method of transmitting data, in a power line system, the method comprising the step of encrypting the data prior to transmitting the data.

22. A method as claimed in claim 21, wherein at least three keys are used, and the keys are changed periodically.

23. A method of determining if two nodes are coupled to the same phase, the method comprising the steps of:
forwarding a data packet to a selected node, the data packet including, at transmission, a first byte of data representing the phase of a transmitting node,
receiving the packet at the selected node,
determining the phase of the selected node at the time of receiving the packet, and
determining the difference between the first byte of data, and the selected node phase.

24. A method as claimed in claim 23, wherein a second byte of data represents the phase of the selected node at the time of receiving the packet.

25. A method as claimed in claim 24, wherein if the difference between the first and second bytes is between:
53 to 11, the nodes are on the same power line phase,
12 to 32, the nodes are 120 degrees out of phase, and
33 to 52, the nodes are 240 degrees out of phase.

26. A data packet adapted to be used in determining the phase difference between two nodes, the packet comprising:
First data representing the phase of the node transmitting the data, and
Second data representing the phase of the node receiving the data, at the time of receiving the packet.

27. A method of determining phase change matching, the method comprising the steps of:
separating the amplitude and quadrature components of a signal, and
comparing a phase change in a relatively noise-free carrier, with a relatively similar phase change in a carrier that has noise imposed on it.

28. A method as claimed in claim 27, wherein the phase matching is determined substantially in accordance with
$$\begin{matrix}{H}_{0} ( t ) = {\int }_{0}^{T} \frac{\vert r ( t ) \vert - r ( t )}{2 r ( t )} \times \frac{\vert s ( t ) \vert - s ( t )}{2 s ( t )} \\ where s ( t ) = \{ \begin{matrix}A sin {ω}_{c} t & 0 \leq t \geq \frac{T}{2} \\ - A sin {ω}_{c} t & \frac{T}{2} < t \geq T\end{matrix} .\end{matrix}$$

29. A method of bit synchronisation, in a power line system, the method comprising the step of using early-late synchronisation.

30. A method of phase locking, comprising comparing the phase when it is determined that the phase is substantially stable.

31. A method as claimed in claim 30, further comprising the step of
when the delta phase signal is asserted, using a relatively finer granularity of phase references to compare to.

32. A method as claimed in claim 31, wherein the phase references a first references that is substantially 22.5 degrees ahead of the current phase estimate and a second reference that is substantially 22.5 degrees behind the phase estimate, and
choosing as a new phase estimate, from the first or the second reference, the reference that correlates the strongest.

33. A substantially fully integratable power line communications device.

34. A device as claimed in claim 33, wherein the device is a power line modem.

35. An interface device adapted of use in a power line system, comprising
a low pass portion and high pass portion.

36. A device as claimed in claim 35, comprising a second order sallen-key filter structure and a second order band pass function.

37. A method of communicating, the method comprising:
addressing a message to a router node with a payload code and a final destination address pre-pended to the message payload.

38. A method as claimed in claim 37, further comprising the steps of addressing the message to a router, and forwarding the enclosed packet from the router to a destination.

39. A method as claimed in claim 37, wherein the payload code is substantially STALON_NM_STALON_ROUTE (0x7E).

40.-46. (canceled)
